(19) United States
(12) Patent Application Publication
(10) Pub. No.: US 2014/0040372 A1
(43) Pub. Date: Feb. 6, 2014

(54) INFORMATION PROCESSING APPARATUS, INFORMATION PROCESSING METHOD AND INFORMATION PROCESSING SYSTEM

(71) Applicant: Sony Corporation, Minato-ku (JP)

(72) Inventors: Naoki KAMIMAEDA, Kanagawa (JP); Masanori MIYAHARA, Tokyo (JP); Shinobu KURIYA, Kanagawa (JP)

(21) Appl. No.: 13/936,474

(22) Filed: Jul. 8, 2013

(30) Foreign Application Priority Data
Aug. 1, 2012 (JP) 2012-170729

(51) Int. Cl. H04L 29/08

(52) U.S. Cl. CPC H04L 67/24
USPC 709/204

(57) ABSTRACT

Provided is an information processing apparatus including a user extraction unit extracting, from second users whose information is set to be viewed by a first user in a service where it is possible to view information sent by other users, a presentation target user to present information to the first user, based on at least one of a first evaluation with respect to each second user by the first user, a second evaluation with respect to each second user within a range of the first user and the second users, and a third evaluation with respect to each second user within a predetermined range of users in the service, a first information extraction unit extracting information presented to the first user, from information sent from the presentation target user, and a presentation control unit controlling presentation of information to the first user.

### BACKGROUND

The present disclosure relates to an information processing apparatus, an information processing method and an information processing system. Specifically, the present disclosure relates to an information processing apparatus, information processing method and information processing system that are suitably used for social services.

Recently, with the popularization of social services, it is daily done to view information sent from other users and share information with other users. According to this, there is suggested a technique of flexibly setting a range to disclose information when the information is sent (e.g. see Japanese Patent Laid-Open No. 2008-262280).

Meanwhile, when the number of friends on a social service increases, the presented information amount also increases, which makes it difficult to check all information. Therefore, in the related art, there is suggested a method of: making a ranking of friends whose information is viewed by the user at high frequency; and preferentially presenting information of high-ranking friends.

### SUMMARY

However, in a case where information is presented based on a ranking of friends whose information is viewed at high frequency, only information of similar friends is presented at any time and other friends' information may not be presented.

Also, the view number of information from a friend with higher information sending frequency increases, and there is a high possibility that the friend is highly ranked. However, since information from the friend is not beneficial at any time, there is concern that less beneficial information is preferentially presented.

Therefore, the present disclosure preferentially presents information beneficial for the user in social services.

According to a first embodiment of the present technology, there is provided an information processing apparatus including a user extraction unit extracting, from second users whose information is set to be viewed by a first user in a service in which it is possible to view information sent by other users, a presentation target user to present information to the first user, based on at least one of a first evaluation with respect to each of the second users by the first user, a second evaluation with respect to each of the second users within a range of the first user and the second users, and a third evaluation with respect to each of the second users within a predetermined range of users in the service, a first information extraction unit extracting information presented to the first user, from information sent from the presentation target user, and a presentation control unit controlling presentation of information to the first user.

The information processing apparatus may further include a second information extraction unit extracting information whose evaluation greatly varies, from information sent from the second users, and a third information extraction unit extracting information presented to the first user, from the information extracted by the first information extraction unit and the second information extraction unit.

The information processing apparatus may further include a fourth information extraction unit extracting information recommended to the first user as information presented to the user, from the information extracted by the third information extraction unit.

The fourth information extraction unit may extract information related to one or more specific items, as the information recommended to the first user.

The second information extraction unit may extract information whose evaluation greatly varies, based on a ratio between an evaluation movement deviation in an immediate period and an evaluation movement deviation in a previous period.

The third information extraction unit may extract information presented to the first user after adding a weight depending on from which of the first information extraction unit and the second information extraction unit the information is extracted.

The information processing apparatus may further include a learning unit learning the weight based on whether information which is presented to the first user and to which the first user givens an evaluation is extracted by the first information extraction unit or the information is extracted by the second information extraction unit.

The information processing apparatus may further include a second information extraction unit extracting information recommended to the first user as information presented to the user, from the information extracted by the first information extraction unit.

The second information extraction unit may extract information related to one or more specific items, as information recommended to the first user.

The user extraction unit may calculate an expectation value that the first user gives a positive evaluation to a comment sent by each of the second users, based on at least one of the first evaluation, the second evaluation, and the third evaluation, and extract the presentation target user based on the expectation value.

The user extraction unit may add a weight according to a time period in which an evaluation is given, and calculate the expectation value.

The user extraction unit may extract the presentation target user by using a result of adding weights to at least two of the first evaluation, the second evaluation, and the third evaluation.

The information processing apparatus may further include a learning unit learning the weights based on a type of an evaluation used to extract the presentation target user who sends information which is presented to the first user and to which the first user gives an evaluation.

According to the first embodiment of the present technology, there is provided an information processing method in an information processing apparatus that provides a service in which it is possible to view information sent by other users, the method including extracting, from second users whose information is set to be viewed by a first user in the service, a presentation target user to present information to the first user, based on at least one of a first evaluation with respect to each of the second users by the first user, a second evaluation with respect to each of the second users within a range of the first user and the second users, and a third evaluation with respect to each of the second users within a predetermined range of users in the service, extracting information presented to the first user, from information sent from the presentation target user, and controlling presentation of information to the first user.

According to a second embodiment of the present technology, there is provided an information processing system including a server providing a service in which it is possible to view information sent by other users, and a client receiving a provision of the service. The server includes a user extraction unit extracting, from second users whose information is set to be viewed by a first user in the service, a presentation target user to present information to the first user, based on at least one of a first evaluation with respect to each of the second users by the first user, a second evaluation with respect to each of the second users within a range of the first user and the second users, and a third evaluation with respect to each of the second users within a predetermined range of users in the service, an information extraction unit extracting information presented to the first user, from information sent from the presentation target user, and a presentation control unit controlling presentation of information to the first user.

According to a third embodiment of the present technology, there is provided an information processing apparatus including a user extraction unit extracting, from second users whose information is set to be viewed by a first user in a service in which it is possible to view information sent by other users, a presentation target user to present information to the first user, based on an evaluation with respect to each of the second users by the first user, an information extraction unit extracting information presented to the first user, from information sent from the presentation target user, and a presentation control unit controlling presentation of information to the first user.

According to the first embodiment of the present technology, from second users whose information is set to be viewed by a first user in a service in which it is possible to view information sent by other users, a presentation target user to present information to the first user is extracted, based on at least one of a first evaluation with respect to each of the second users by the first user, a second evaluation with respect to each of the second users within a range of the first user and the second users, and a third evaluation with respect to each of the second users within a predetermined range of users in the service, information presented to the first user is extracted, from information sent from the presentation target user, and presentation of information to the first user is controlled.

According to the second embodiment of the present technology, in an information processing system including a server providing a service in which it is possible to view information sent by other users, and a client receiving a provision of the service, by the server, from second users whose information is set to be viewed by a first user in the service, a presentation target user to present information to the first user is extracted, based on at least one of a first evaluation with respect to each of the second users by the first user, a second evaluation with respect to each of the second users within a range of the first user and the second users, and a third evaluation with respect to each of the second users within a predetermined range of users in the service, information presented to the first user is extracted, from information sent from the presentation target user, and presentation of information to the first user is controlled.

According to the third embodiment of the present technology, from second users whose information is set to be viewed by a first user in a service in which it is possible to view information sent by other users, a presentation target user to present information to the first user is extracted, based on an evaluation with respect to each of the second users by the first user, information presented to the first user is extracted, from information sent from the presentation target user, and presentation of information to the first user is controlled.

According to the first to third embodiments of the present disclosure, it is possible to preferentially present information beneficial for the user in social services.

### BRIEF DESCRIPTION OF THE DRAWINGS

FIG. 1 is a block diagram illustrating an embodiment of an information processing system to which the present disclosure is applied;

FIG. 2 is a diagram for explaining an outline of comment filtering processing according to the first embodiment;

FIG. 3 is a block diagram illustrating a functional configuration example of a server according to the first embodiment;

FIG. 4 is a diagram illustrating a configuration example of data of a friend comment DB;

FIG. 5 is a block diagram illustrating a functional configuration example of a friend comment filtering unit according to the first embodiment;

FIG. 6 is a diagram illustrating a configuration example of data of a feedback DB;

FIG. 7 is a diagram illustrating a configuration example of data of a friend DB;

FIG. 8 is a diagram illustrating a functional configuration example of a client;

FIG. 9 is a flowchart for explaining processing at the time of feedback reception according to the first embodiment;

FIG. 10 is a flowchart for explaining details of friend DB update processing;

FIG. 11 is a flowchart for explaining comment presentation processing according to the first embodiment;

FIG. 12 is a flowchart for explaining details of friend comment filtering processing according to the first embodiment;

FIG. 13 is a flowchart for explaining details of friend filtering processing according to the first embodiment;

FIG. 14 is a diagram for explaining a generation method of a friend list (individual);

FIG. 15 is a flowchart for explaining details of friend filtering processing according to the second embodiment;

FIG. 16 is a flowchart for explaining processing at the time of feedback reception according to the second embodiment;

FIG. 17 is a diagram for explaining a generation method of a friend list (friends);

FIG. 18 is a flowchart for explaining processing at the time of feedback reception according to the third embodiment;

FIG. 19 is a diagram for explaining a generation method of a friend list (entirety);

FIG. 20 is a block diagram illustrating a functional configuration example of a friend comment filtering unit according to the second embodiment;

FIG. 21 is a block diagram illustrating a functional configuration example of a friend list synthesis unit;

FIG. 22 is a flowchart for explaining details of friend comment filtering processing according to the second embodiment;

FIG. 23 is a flowchart for explaining details of friend list synthesis weight learning processing;

FIG. 24 is a diagram for explaining an outline of comment filtering processing according to the second embodiment;

FIG. 25 is a block diagram illustrating a functional configuration example of a server according to the second embodiment;

FIG. 26 is a block diagram illustrating a functional configuration example of a trend analysis unit;

FIG. 27 is a block diagram illustrating a functional configuration example of a comment list synthesis unit;

FIG. 28 is a flowchart for explaining comment presentation processing according to the second embodiment;

FIG. 29 is a flowchart for explaining details of trend analysis processing;

FIG. 30 is a flowchart for explaining details of comment list synthesis processing;

FIG. 31 is a flowchart for explaining details of comment list synthesis weight learning processing;

FIG. 32 is a diagram for explaining an outline of comment filtering processing according to the third embodiment;

FIG. 33 is a block diagram illustrating a functional configuration example of a server according to the third embodiment;

FIG. 34 is a block diagram illustrating a functional configuration example of a recommendation comment extraction unit according to the first embodiment;

FIG. 35 is a diagram illustrating a configuration example of data of a decision feature DB;

FIG. 36 is a flowchart for explaining comment presentation processing according to the third embodiment;

FIG. 37 is a flowchart for explaining recommendation comment extraction processing according to the first embodiment;

FIG. 38 is a block diagram illustrating a functional configuration example of a recommendation comment extraction unit according to the second embodiment;

FIG. 39 is a flowchart for explaining recommendation comment extraction processing according to the second embodiment;

FIG. 40 is a diagram for explaining an outline of comment filtering processing according to the fourth embodiment;

FIG. 41 is a block diagram illustrating a functional configuration example of a server according to the fourth embodiment;

FIG. 42 is a flowchart for explaining comment presentation processing according to the fourth embodiment; and

FIG. 43 is a block diagram illustrating a configuration example of a computer.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

In the following, formats to implement the present disclosure (hereinafter referred to as “embodiments”) are explained. Also, the explanation is given in the following order.

1. Configuration example of information processing system

2. First embodiment (friend comment filtering)

3. Second embodiment (friend comment filtering+trend analysis)

4. Third embodiment (friend comment filtering+recommendation comment extraction)

5. Fourth embodiment (friend comment filtering+trend analysis+recommendation comment extraction)

6. Alternation example

### 1. Configuration Example of Information Processing System

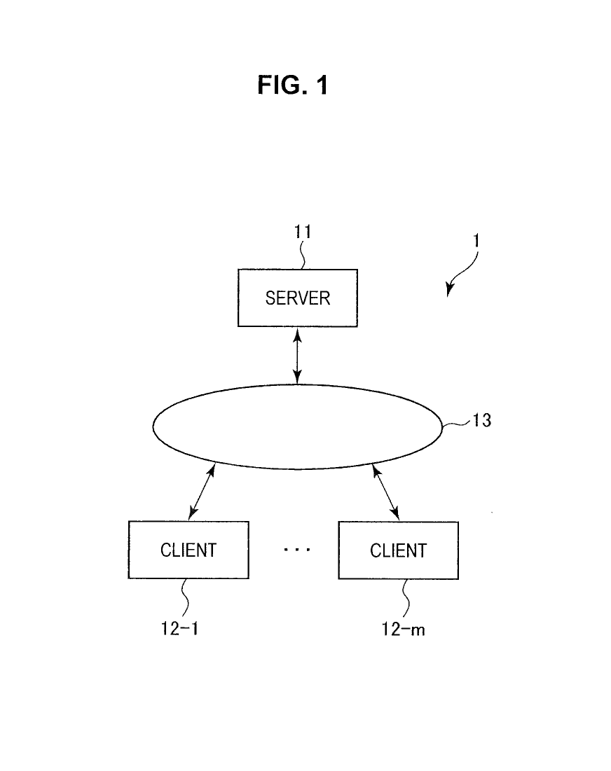

FIG. 1 is a block diagram illustrating an embodiment of an information processing system to which the present disclosure is applied.

An information processing system 1 is formed including a server 11 and clients 12-1 to 12-m. The server 11 and the clients 12-1 to 12-m are mutually connected through a network 13.

In the following, in a case where the clients 12-1 to 12-m are not requested to be individually distinguished, they are simply referred to as “clients 12.”

The server 11 provides a social service to each client 12. Next, the user uses the client 12 to use the social service provided by the server 11.

Here, as long as it is possible to at least view information sent by other users and each user has a function of being able to set other users whose information is viewed, the social service type is not especially limited.

Also, the kind of information sent from each user is not especially limited, and, for example, it may include text data such as comments, image, sound, position information and information related to user's activities (such as a service use history and updating of the profile). Further, the information sent from the user includes not only information that is actively sent in a voluntary manner but also information that is automatically sent without depending on a user's intention, such as position information and information related to activities. In the latter case, for example, it is assumed that the user performs setting in advance so as to allow information to be automatically transmitted from the client 12 to the server 11 and allow the server 11 to automatically acquire information from the client 12.

Also, as described later, the social service provided by the server 11 has an information filtering function of filtering information sent by other users according to the user who views the information (hereafter referred to as “viewer”) and presenting it.

Also, in the following, for ease of explanation, an explanation is given where the kind of information presented to each user on a social service is limited to comments. Therefore, in the following, an explanation is mainly given to a function of filtering and presenting comments sent by other users according to a viewer (hereinafter referred to as “comment filtering function”) in the information filtering function.

The client 12 is formed with a device that can use the social service provided by the server 11, such as a personal computer, a portable information terminal, a mobile phone and a smartphone.

### 2. First Embodiment

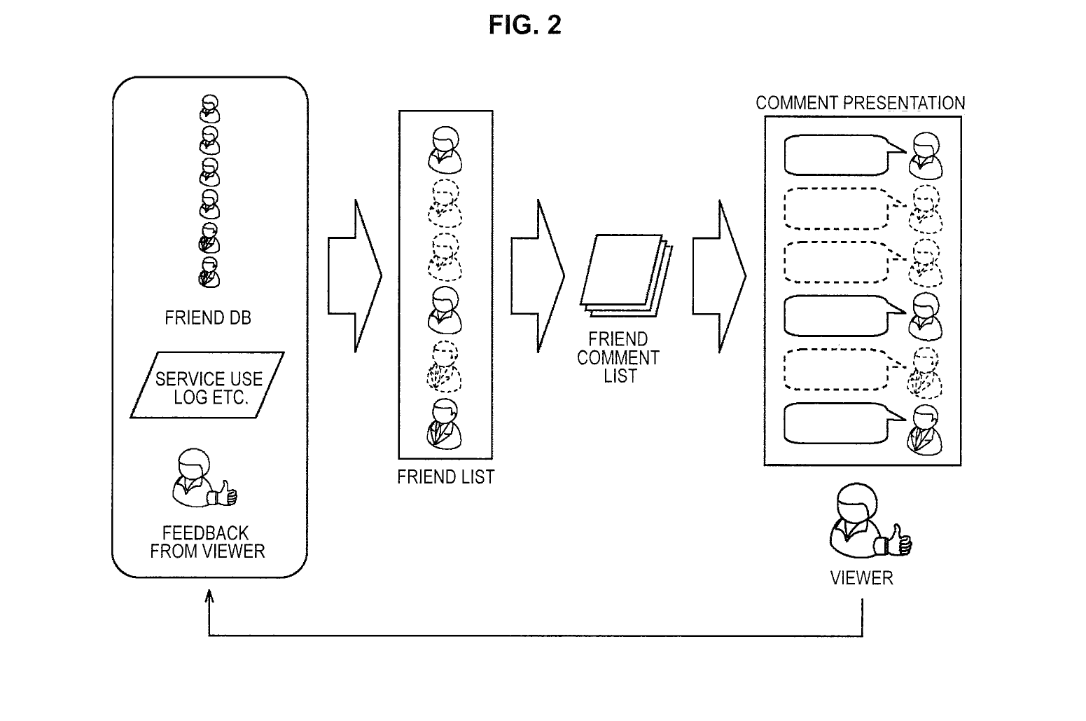

Next, with reference to FIG. 2 to FIG. 23, the first embodiment of the present disclosure is explained.

### [Outline of Comment Filtering Function According to the First Embodiment]

First, with reference to FIG. 2, an explanation is given to an outline of a comment filtering function realized in the first embodiment of the present disclosure.

In this comment filtering function, a target user (hereafter referred to as “presentation target user”) whose comment is presented to a viewer is extracted from friends on a social service of the viewer who views comments. Subsequently, a comment sent from the presentation target user is presented to the viewer.

Specifically, first, the presentation target user is extracted from a friend DB (database) registering viewer's friends, based on a social service use log of the viewer or a feedback given from the viewer for friend's comment or the friend himself/herself. Subsequently, a friend list including the presentation target user is generated.

Here, the friend denotes a different user bi-directionally linked to a certain user on a social service, that is, a different user having a bidirectional connection with a certain user on a social service. For example, in a case where users A and B establish a bidirectional link, that is, in a case where the users A and B have a friend relationship, for example, it is set such that a comment sent from one can be viewed by the other.

Also, the feedback with respect to the comment sent by the friend or the friend himself/herself denotes an evaluation with respect to the comment or the friend himself/herself. For example, the feedback is given using “Likes”, “Dislikes”, a five-grade evaluation or a specific value such as a point, or given using a sentence, and so on. Also, the feedback includes not only a feedback which is explicitly given by each user (hereinafter referred to as “explicit feedback”) but also a feedback which is implicitly given (hereafter referred to as “implicit feedback”). It is assumed that the implicit feedback is given based on information acquired from the use log of each user, such as comment view, comment disregard and common play on a social service.

Next, a comment presented to a viewer is extracted from comments sent by the presentation target user included in the friend list, and a friend comment list including the extracted comments is generated.

Subsequently, the comments included in the friend comment list are presented to the viewer. Also, in a case where the viewer gives a feedback with respect to the presented comment, the feedback is reflected to generation of a subsequent friend list.

### [Configuration Example of Server 11a]

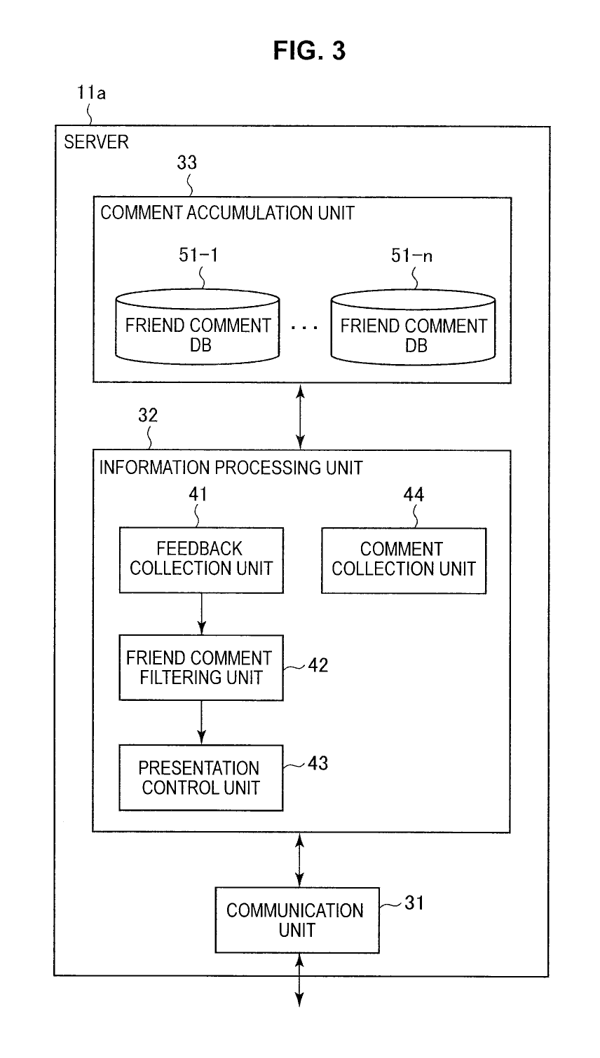

FIG. 3 is a block diagram illustrating a functional configuration example of a server 11a which is the first embodiment of the server 11 of the information processing system 1. Here, FIG. 3 illustrates a configuration example of a part to chiefly perform processing related to comment presentation in the functions of the server 11a.

The server 11a is formed including a communication unit 31, an information processing unit 32 and a comment accumulation unit 33.

The communication unit 31 and each part of the information processing unit 32 can mutually access each other. Also, each part of the information processing unit 32 can access each part of the comment accumulation unit 33.

The communication unit 31 communicates with each client 12 through the network 13 and transmits and receives various kinds of information and instructions related to the social service.

The information processing unit 32 performs various kinds of processing related to the social service. The information processing unit 32 is formed including a feedback collection unit 41, a friend comment filtering unit 42, a presentation control unit 43 and a comment collection unit 44.

The feedback collection unit 41 receives the feedback which each user gives with respect to other users' comments or other users themselves, from each client 12 through the network 13 and the communication unit 31, and supplies them to the friend comment filtering unit 42.

As described later, the friend comment filtering unit 42 extracts a comment presented to the viewer from comments sent by viewer's friends and generates a friend comment list including the extracted comment. Subsequently, the friend comment filtering unit 42 supplies the generated friend comment list to the presentation control unit 43.

The presentation control unit 43 controls the presentation of the comments included in the friend comment list. Specifically, the presentation control unit 43 generates presentation control data to present the comments included in the friend comment list in the client 12 of the viewer. Subsequently, the presentation control unit 43 transmits the generated presentation control data to the client 12 of the viewer through the communication unit 31 and the network 13.

The comment collection unit 44 receives the comment sent by each user, from each client 12 through the network 13 and the communication unit 31, and accumulates it in friend comment DB's (databases) 51-1 to 51-n stored in the comment accumulation unit 33.

The friend comment DB's 51-1 to 51-n are installed every user of the social service and accumulate information of the comment sent by each user's friend. Here, in a case where the friend comment DB's 51-1 to 51-n are not requested to be individually distinguished, they are simply referred to as “friend comment DB 51.”

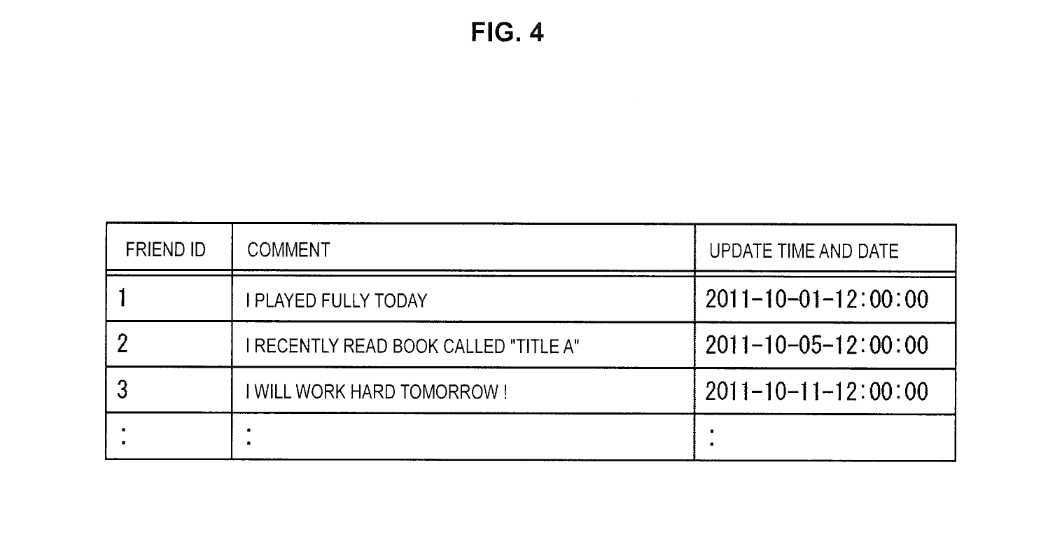

FIG. 4 illustrates a data configuration example of the friend comment DB 51. The friend comment DB 51 is formed including at least three items of a friend ID, comment and update time and date.

The friend ID denotes an ID allocated to individually identify friends of a target user.

The comment denotes content of the comment actually sent from each friend.

The update time and date denotes the time and date when each comment is registered in the friend comment DB. Therefore, the update time and date is substantially equal to the time and date when each comment is sent.

Here, although an illustration is omitted, with respect to each comment, the friend comment DB 51 accumulates: the time and date when a feedback is given; the ID of the user who assigns the feedback; and the type of the assigned feedback (hereafter referred to as “feedback type”), and so on.

### [Configuration Example of Friend Comment Filtering Unit 42a]

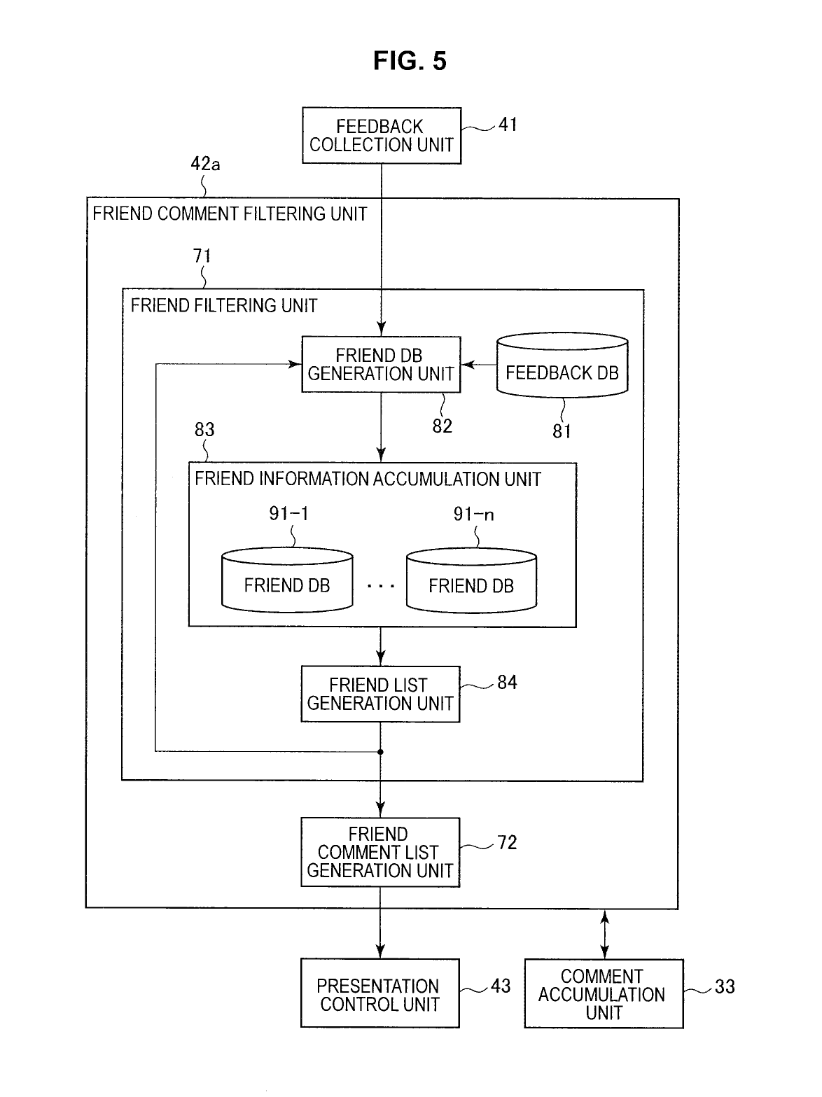

FIG. 5 is a block diagram illustrating a functional configuration example of a friend comment filtering unit 42a which is the first embodiment of the friend comment filtering unit 42 of the server 11a.

The friend comment filtering unit 42a is formed including a friend filtering unit 71 and a friend comment list generation unit 72.

The friend filtering unit 71 extracts a presentation target user whose comment is presented to the viewer, from viewer's friends, and generates a friend list including the extracted presentation target user. The friend filtering unit 71 is formed including a feedback DB (database) 81, a friend DB (database) generation unit 82, a friend information accumulation unit 83 and a friend list generation unit 84.

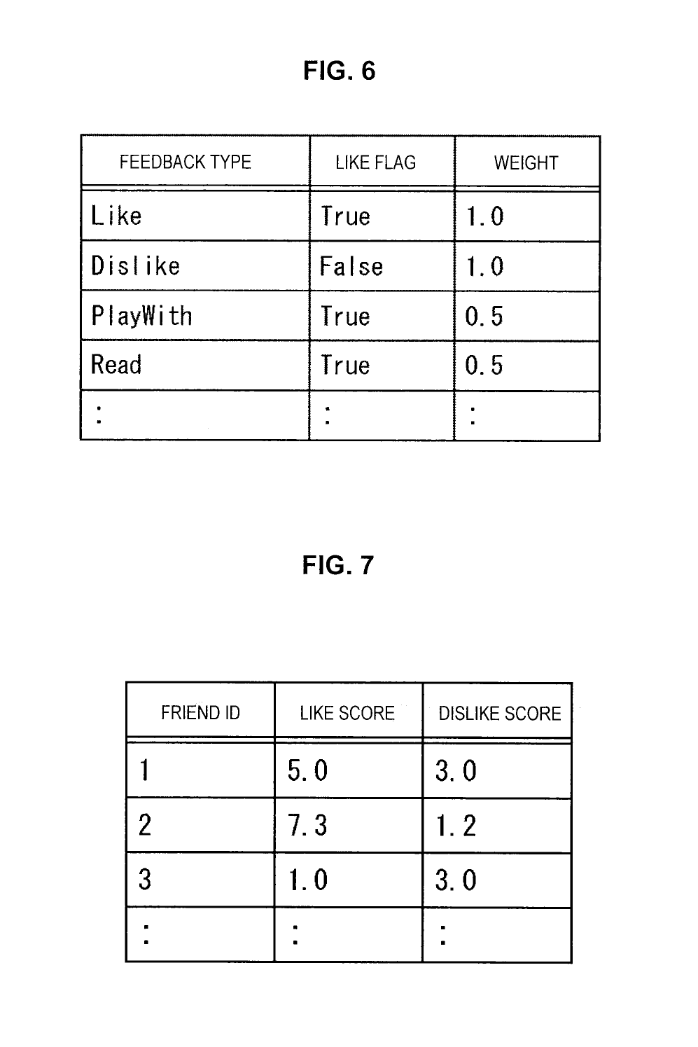

The feedback DB 81 defines the type of the feedback given from each user. FIG. 6 illustrates a data configuration example of the feedback DB 81. The feedback DB 81 is formed including at least three items of a feedback type, like flag and weight.

The feedback type defines the feedback type. For example, “Like” is a feedback in a case where the user explicitly gives a positive evaluation “like” to comments of other users. “Dislike” is a feedback in a case where the user explicitly gives a negative feedback “dislike” to comments of other users. “PlayWith” is a feedback implicitly given in a case where the user plays together with other users in a game or the like on a social service. “Read” is a feedback implicitly given in a case where the user reads comments of other users.

The like flag denotes a flag to decide whether each feedback is the one to show a positive (like) evaluation or each feedback is the one to show a negative (dislike) evaluation. Specifically, a feedback with a like flag value “True” denotes a positive feedback and a feedback with a like flag value “False” denotes a negative feedback.

The weight indicates the positive or negative degree of each feedback and the degree increases as the value is larger. For example, although the feedback types “Like” and “PlayWith” are both positive feedbacks, since the weight of “Like” is larger, the positive degree is larger.

The friend DB generation unit 82 generates and updates friend DB's 91-1 to 91-n stored in the friend information accumulation unit 83, based on each user's feedback supplied from the feedback collection unit 41, the feedback DB 81 and the friend list supplied from the friend list generation unit 84.

The friend DB's 91-1 to 91-n are installed every user of the social service, and accumulate the evaluation to each user's friend. Here, in a case where the friend DB's 91-1 to 91-n are not requested to be individually distinguished, they are referred to as “friend DB 91.”

FIG. 7 illustrates a data configuration example of the friend DB 91. The friend DB 91 is formed including at least three items of friend ID, like score and disliked score.

The friend ID denotes an ID allocated to individually identify friends of a target user.

The like score indicates how the target user likes each friend, and, as the value is higher, it shows that the like degree of the friend is higher.

The dislike score indicates how the target user dislikes each friend, and, as the value is higher, it shows that the dislike degree of the friend is higher.

The friend list generation unit 84 extracts a presentation target user whose comment is presented to the viewer, from viewer's friends, based on the viewer's friend DB 91. The friend list generation unit 84 generates a friend list including the extracted presentation target user and supplies the generated friend list to the friend comment list generation unit 72 and the friend DB generation unit 82.

The friend comment list generation unit 72 extracts a comment presented to the viewer, from the viewer's friend comment DB 51, among comments sent by the presentation target user included in the friend list. The friend comment list generation unit 72 generates a friend comment list including the extracted comment and supplies the generated friend comment list to the presentation control unit 43.

### [Configuration Example of Client 12]

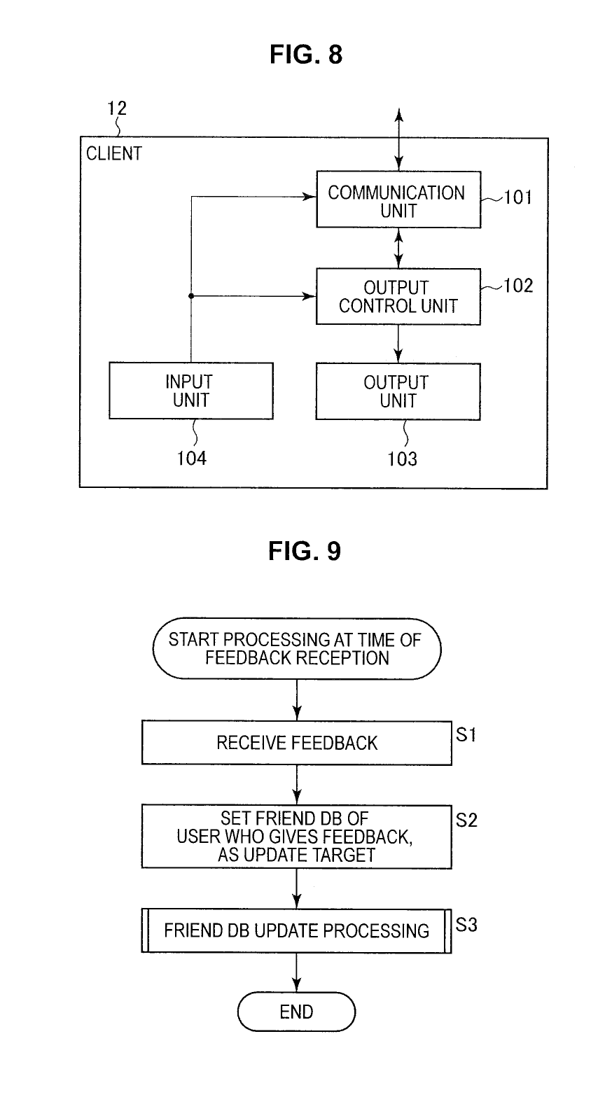

FIG. 8 is a block diagram illustrating a functional configuration example of the client 12.

The client 12 is formed including a communication unit 101, an output control unit 102, an output unit 103 and an input unit 104. Here, FIG. 8 illustrates a configuration example of parts to perform processing chiefly related to comment presentation and feedback assignment in functions of the client 12.

The communication unit 101 communicates with each server 11 through the network 13 and transmits and receives various kinds of information and instructions related to a social service.

The output control unit 102 receives various kinds of information related to the social service through the network 13 and the communication unit 101, and, based on the received information, controls an output from the output unit 103 such as an image and sound in the social service. For example, the output control unit 102 receives presentation control data to present the comment of each user, from the server 11 through the network 13 and the communication unit 101, and controls the presentation of comments in the output unit 103.

The output unit 103 includes, for example, various display devices such as a display, and various sound output devices such as a speaker and a sound output terminal.

The input unit 104 includes various input devices such as a keyboard, a mouse, a touch panel and microphones. The input unit 104 supplies information or instruction input by the user to the communication unit 101 and the output control unit 102.

### [Processing in Server 11a]

Next, with reference to FIG. 9 to FIG. 14, processing in the server 11a is explained.

### (Processing at the Time of Feedback Reception)

First, with reference to the flowchart in FIG. 9, an explanation is given to processing in a case where the server 11a receives a feedback by the user from the client 12. Here, for example, this processing starts at the time when an arbitrary user of a social service explicitly or implicitly gives a feedback to comments of other users in the client 12 and the information is transmitted from the client 12 to the server 11a through the network 13.

In step S1, the feedback collection unit 41 receives information related to a feedback transmitted from the client 12, through the communication unit 31. The feedback collection unit 41 supplies the information related to the received feedback to friend DB generation unit 82 of the friend comment filtering unit 42a.

In step S2, the friend DB generation unit 82 sets a friend DB of the user who gives the feedback (i.e. the user of the sending source of the feedback), to an update target.

In step S3, the friend DB generation unit 82 performs friend DB update processing for the friend DB set as the update target, and terminates the processing at the time of feedback reception.

### (Friend DB Update Processing)

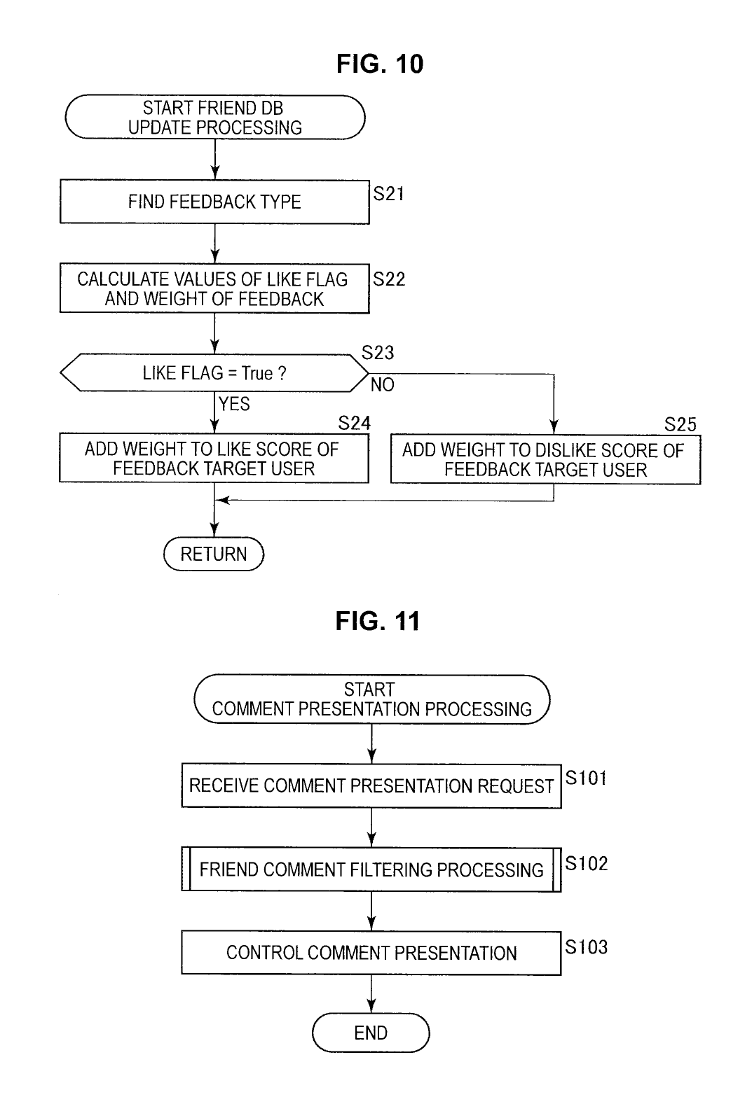

Here, with reference to FIG. 10, an explanation is given to details of the friend DB update processing.

In step S21, the friend DB generation unit 82 finds a feedback type of a received feedback based on the feedback DB 81.

In step S22, the friend DB generation unit 82 finds the values of a like flag and weight of the received feedback, based on the found feedback type and the feedback DB 81.

In step S23, the friend DB generation unit 82 decides whether the found value of the like flag is “True.” In a case where it is decided that the value of the like flag is “True,” the processing proceeds to step S24.

In step S24, the friend DB generation unit 82 adds the found weight to the like score of the feedback target user. By this means, in the friend DB 91 of the user who gave the feedback, the like score of the friend to whom the feedback was given increases by the found weight.

After that, the friend DB update processing is terminated.

On the other hand, in step S23, in a case where it is decided that the value of the like flag is “False,” processing proceeds to step S25.

In step S25, the friend DB generation unit 82 adds the found weight to a disliked score of the feedback target user. By this means, in the friend DB 91 of the user who gave the feedback, the dislike score of the friend to whom the feedback was given increases by the found weight.

After that, the friend DB update processing is terminated.

Subsequently, the processing in FIG. 9 is performed every time each user of the social service gives a feedback to friend's comment or the like, and the friend DB 91 of each user is updated.

Therefore, the friend DB of each user is updated based on only the feedback given by the target user. That is, in the like scores and dislike scores of the friend DB of the user A, only an evaluation of the user A with respect to the comment of each friend of the user A is reflected.

### (Comment Presentation Processing)

Next, with reference to the flowchart in FIG. 11, an explanation is given to comment presentation processing performed by the server 11a. Here, for example, this processing starts at the time when an arbitrary user of the social service (e.g. viewer) performs an operation of displaying friend's comment in the client 12 and, as a result, a request for comment presentation is transmitted from the client 12 to the server 11a through the network 13.

In step S101, the friend comment filtering unit 42a receives the comment presentation request transmitted from the client 12, through the communication unit 31.

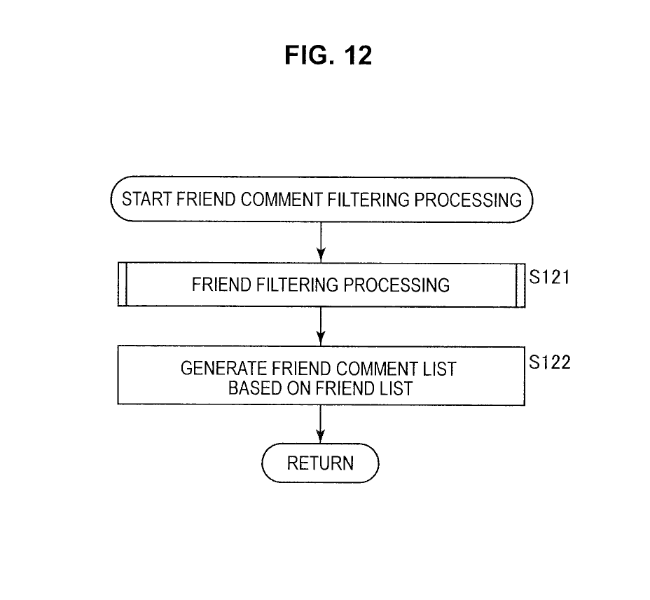

In step S102, the friend comment filtering unit 42a performs friend comment filtering processing. Here, with reference to the flowchart in FIG. 12, an explanation is given to details of the friend comment filtering processing.

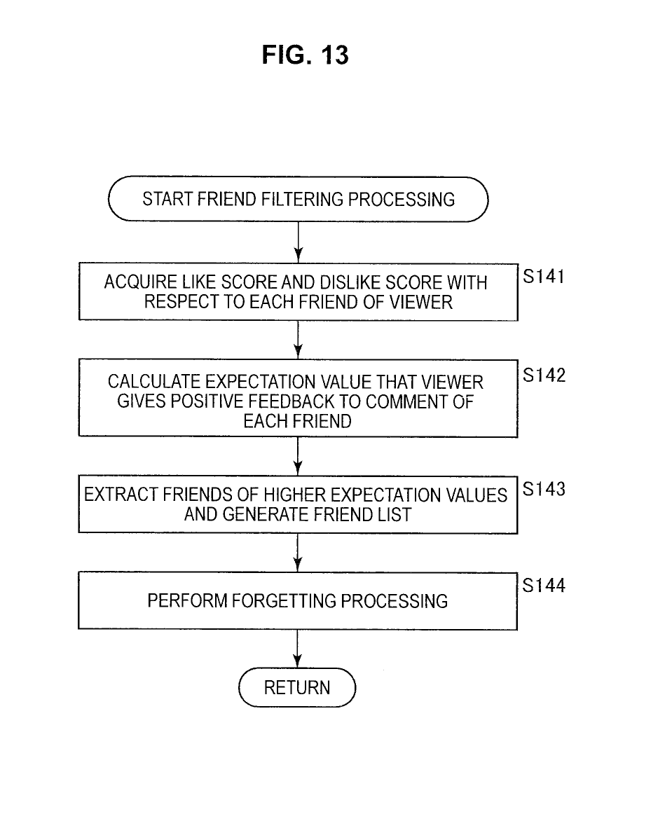

In step S121, the friend filtering unit 71 performs the friend filtering processing. Here, with reference to the flowchart in FIG. 13, an explanation is given to details of the friend filtering processing.

In step S141, the friend list generation unit 84 acquires the like score and dislike score with respect to each friend of the viewer, from the friend DB 91 of the viewer.

In step S142, the friend list generation unit 84 calculates an expectation value that the viewer gives a positive feedback to the comment of each friend. Here, although an expectation value calculation method is not limited to the specific one, for example, the following three methods are possible.

For example, as the first method, there is a method of using the like score with respect to each friend of the viewer as is, as an expectation value.

Also, as the second method, there is a method of using a value subtracting the dislike score from the like score with respect to each friend of the viewer, as an expectation value.

Further, as the third method, there is a method of calculating an expectation value E(k) with respect to friend “k” of the viewer by using following Expressions (1) to (3).

$$\begin{matrix}Expectation value E ( k ) = μ ( k ) + α \cdot {σ}^{2} ( k ) & ( 1 ) \\ Average μ ( k ) = \frac{{LS}_{k}}{{LS}_{k} + {DS}_{k}} & ( 2 ) \\ Variance {σ}^{2} ( k ) = \frac{{LS}_{k} \cdot {DS}_{k}}{{( {LS}_{k} + {DS}_{k} )}^{2} ( {LS}_{k} + {DS}_{k + 1} )} & ( 3 )\end{matrix}$$

Here, “LSₖ” denotes a like score with respect to viewer's friend “k,” and “DSₖ” denotes a dislike score with respect to viewer's friend “k.” Also, “α” denotes a risk rate at which a friend to whom the viewer gives a positive feedback is cast away.

In step S143, the friend list generation unit 84 extracts friends of higher expectation values and generates a friend list. For example, the friend list generation unit 84 extracts a predetermined number of friends in order from the one with the highest expectation value, from viewer's friends, as presentation target users. Alternatively, for example, the friend list generation unit 84 extracts friends with expectation values equal to or greater than a predetermined threshold, from viewer's friends, as presentation target users. Subsequently, the friend list generation unit 84 generates a friend list including the extracted presentation target users and their expectation values, and supplies it to the friend comment list generation unit 72 and friend DB generation unit 82.

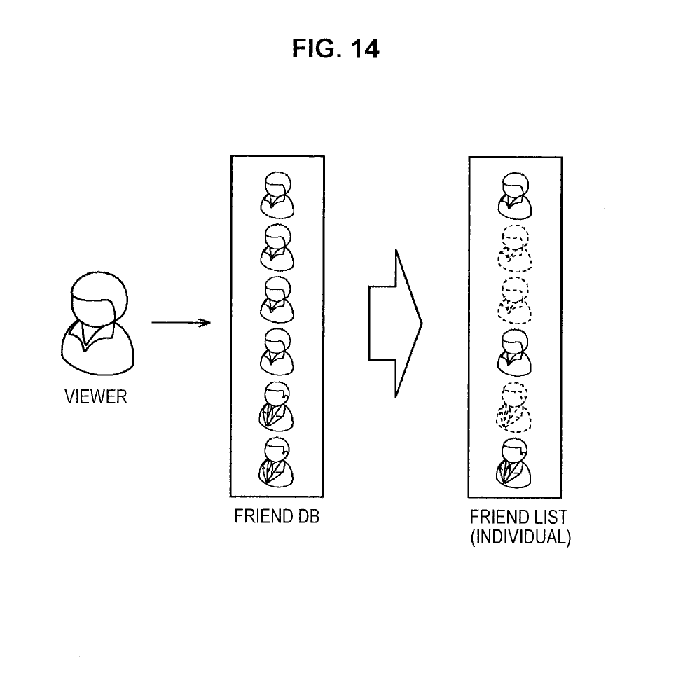

As described above, since the friend DB of each user is updated based on only a feedback given by a target user, as illustrated in FIG. 14, a friend list is generated from the friend DB updated based on only the viewer's feedback. Therefore, the user (i.e. presentation target user) included in the friend list is a friend with a high evaluation in the viewer's friends. Specifically, the presentation target user included in the friend list is a friend with a high possibility that the viewer is interested in a comment and gives a positive feedback (which may be hereafter referred to as “success rate”).

Also, in the following, in a case where it is requested to distinguish the friend list generated by the method illustrated in FIG. 14 from a friend list generated by other methods to be described later, it is referred to as “friend list (individual).”

In step S144, the friend DB generation unit 82 performs forgetting processing. That is, the friend DB generation unit 82 performs processing of forgetting a past positive or negative evaluation with respect to the comment of each viewer's friend.

For example, in a case where an expectation value is calculated by the above first or second method, the friend DB generation unit 82 updates the viewer's friend DB by multiplying a predetermined damping constant ρ(0<ρ≦1) by the like score and dislike score with respect to each viewer's friend.

Also, for example, in a case where the expectation value is calculated by the above third method, the friend DB generation unit 82 updates the viewer's friend DB by using following Expressions (4) and (5) and updating the like scores and dislike scores of friends not included in the friend list among viewer's friends.

$$\begin{matrix}new {DS}_{k} = {DS}_{k} \times η & ( 4 ) \\ new {LS}_{k} = \{ \begin{matrix}{LS}_{k} \times η & \text{:} {LS}_{k} > ɛ \\ {LS}_{k} & \text{:} {LS}_{k} ≦ ɛ\end{matrix} & ( 5 )\end{matrix}$$

Here, “η” denotes a forgetting coefficient which is set within the range of 0≦η≦1. Also, ε denotes a forgetting control constant, and, in a case where the like score is LSk≦ε as illustrated in Expression (5), the like score is suppressed to be forgotten. Therefore, the lower limit value of like score LSₖ is around forgetting control constant ε. On the other hand, the lower limit value of dislike score DSₖ is 0.

By performing this forgetting processing, the expectation value with respect to each viewer's friend is calculated by applying a weight according to the time when the viewer gives an evaluation. That is, the expectation value is calculated such that a newer evaluation is more weighted and an older evaluation is less weighted.

Here, it is possible to omit the forgetting processing in step S144.

After that, the friend filtering processing is terminated.

Returning to FIG. 12, in step S122, the friend comment list generation unit 72 generates a friend comment list based on the friend list. For example, the friend comment list generation unit 72 extracts the latest comment of each presentation target user included in the friend list, from the friend comment DB 51 for the viewer. Alternatively, for example, the friend comment list generation unit 72 extracts a predetermined number of new comments from all comments sent by a presentation target user. Therefore, in the former case, the comment of each presentation target user is extracted one by one. On the other hand, in the latter case, it is not limited that comments of all presentation target users are extracted, and there is a case where a plurality of comments by the same presentation target user are extracted.

Also, the friend comment list generation unit 72 sets an expectation value with respect to the user who sent each comment, as the expectation value of each extracted comment. Subsequently, the friend comment list generation unit 72 generates a friend comment list including the extracted comments and their expectation values, and supplies it to the presentation control unit 43.

After that, the friend comment filtering processing is terminated.

Returning to FIG. 11, in step S103, the presentation control unit 43 controls the presentation of comments. Specifically, the presentation control unit 43 generates presentation control data to present the comments included in the friend comment list. Subsequently, the presentation control unit 43 transmits the generated presentation control data to the viewer's client 12 through the communication unit 31 and the network 13.

The output control unit 102 of the viewer's client 12 receives the presentation control data through the communication unit 101. The output control unit 102 arranges the comments included in the friend comment list in order from the latest one, for example, based on the presentation control data, and displays the result in the output unit 103.

After that, the comment presentation processing is terminated.

By this means, the viewer can preferentially view a comment with a high possibility (success rate) that a positive feedback is given, that is, a comment that is highly likely to be beneficial for the viewer.

Therefore, compared with a case where comments are presented simply based on the ranking of friends viewed at high frequency, it is possible to present a more beneficial comment for the viewer. That is, for example, a comment of a friend with a low sending frequency and a high possibility of sending a comment beneficial for the viewer, is preferentially presented. By contrast, a comment of a friend with a high sending frequency and a low possibility of sending a comment beneficial for the viewer, is less likely to be presented.

Also, by the forgetting processing, the evaluation with respect to each friend by past viewer's feedbacks is forgotten such that it is possible to prevent the user (or friend) whose comment is presented, from being fixed.

### [Alternation Example of Friend Filtering Processing]

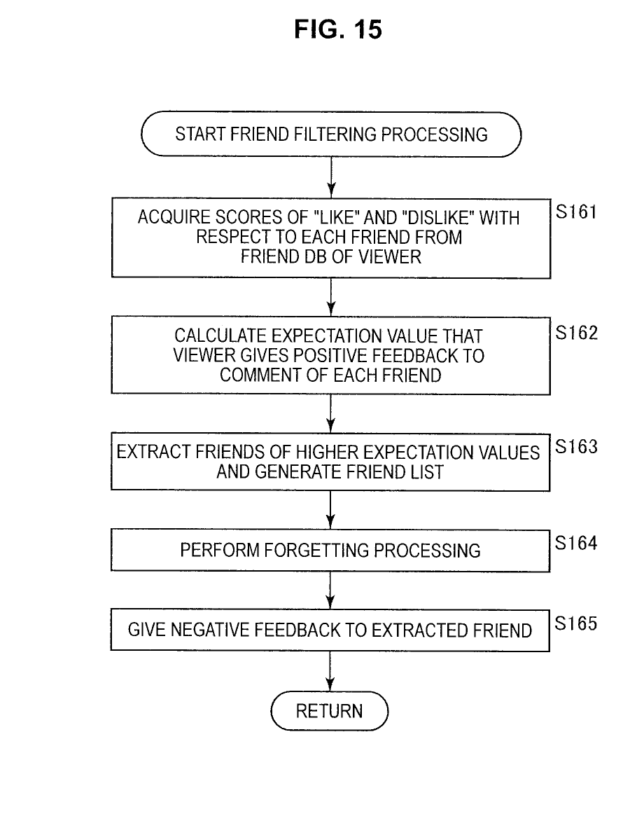

Next, with reference to the flowchart in FIG. 15, an explanation is given to an alternation example of the friend filtering processing in step S121 in FIG. 12. Here, for example, it is assumed that this processing is applied to a social service in which the user cannot explicitly give a negative feedback.

The processing in steps S161 to S164 is similar to the processing in steps S141 to S144 in FIG. 13.

In step S165, the friend DB generation unit 82 gives a negative feedback to an extracted friend. For example, the friend DB generation unit 82 updates the viewer's friend DB 91 by adding a predetermined weight (e.g. a weight with respect to “Dislike” in FIG. 6) to a dislike score of a friend included in the friend list among viewer's friends.

After that, the friend filtering processing is terminated.

The processing in this step S165 denotes processing of automatically giving a negative feedback on the side of the server 11a since the viewer cannot explicitly give a negative feedback with respect to a comment. That is, a negative feedback is automatically given to a friend who sends a comment to which a positive feedback is not given among comments presented to the viewer. By this means, it is possible to prevent a friend whose comment is presented, from being fixed.

Here, for example, a negative feedback may not be given to a friend who is included in the friend list and whose comment is not finally presented to the viewer.

### [Alternation Example 1 of Processing at the Time of Feedback Reception]

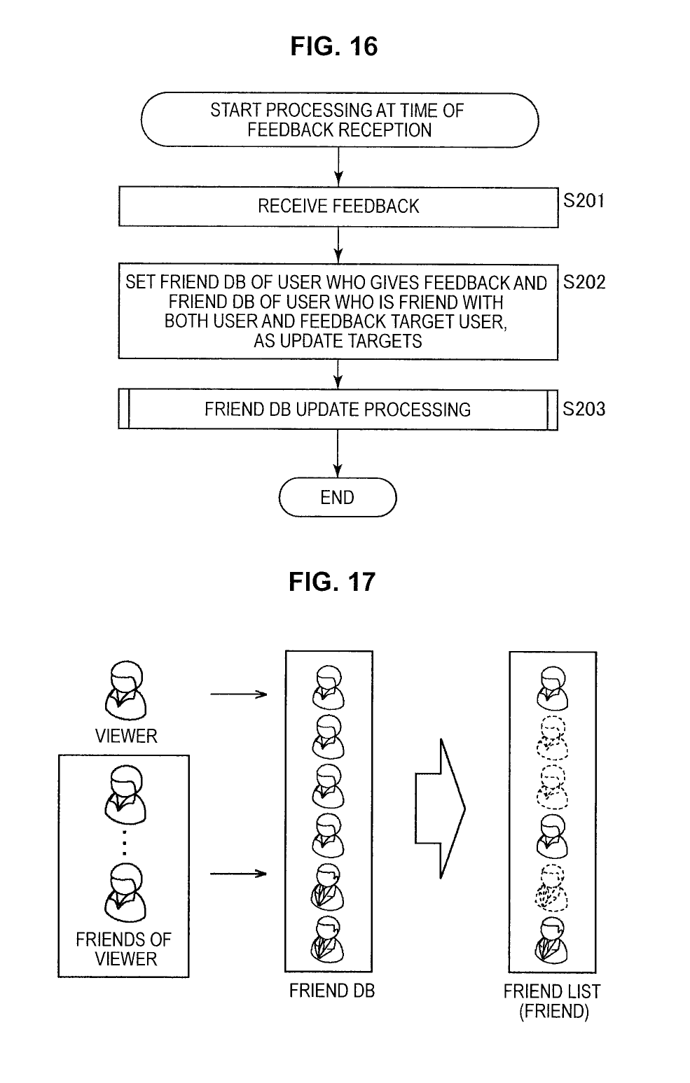

With reference to FIG. 16 and FIG. 17, an explanation is given to the first alternation example of processing at the time of feedback reception instead of FIG. 9 described above.

In step S201, by the processing similar to that in step S1 in FIG. 9, Information related to a feedback transmitted from the client 12 is received.

In step S202, the friend DB generation unit 82 sets, as an update target, a friend DB of a user who givens a feedback, and a friend DB of a user who is a friend with both the user and the feedback target user.

In step S203, with reference to FIG. 10, the friend DB generation unit 82 performs the above friend DB update processing on the friend DB set as the update target, and the processing at the time of feedback reception is terminated.

By this means, for example, in a case where a user A (i.e. a user who gives a feedback) gives a feedback to a comment of a user B (i.e. a feedback target user), first, the like score and dislike score of the user B in the user DB of the user A are updated. Also, a like score and dislike score of the user B in the user DB of a user are updated, where the user is a friend with the user B among friends of the user A.

Therefore, the friend DB of each user is updated based on a feedback given by a target user in addition to a feedback given by a friend of the user. That is, an evaluation of the user A and an evaluation of a friend of the user A, which are directed to each friend of the user A, are reflected to the like score and dislike score of the friend DB of the user A.

Therefore, as illustrated in FIG. 17, a friend list of the viewer is generated from the friend DB updated based on feedbacks given from the viewer and viewer's friend to a friend of the viewer. As a result, the user (i.e. the presentation target user) included in the friend list is a friend with a high evaluation within a range of the viewer and viewer's friends among viewer's friends, to be more specific, a friend with a high possibility (or success rate) that the viewer and viewer's friends give positive feedbacks to a comment.

Therefore, by extracting a comment based on this friend list and presenting it to the viewer, the comment decided to be beneficial from a standpoint of viewer's friends including the viewer, is presented to the viewer among comments of viewer's friends. By this means, compared with the case based on only viewer's standpoint, it is possible to preferentially present a beneficial comment with respect to various wider topics to the viewer.

Also, in the following, in a case where it is requested to distinguish the friend list generated by the procedure illustrated in FIG. 17 from a friend list generated by other methods, it is referred to as “friend list (friend).”

### [Alternation Example 2 of Processing at the Time of Feedback Reception]

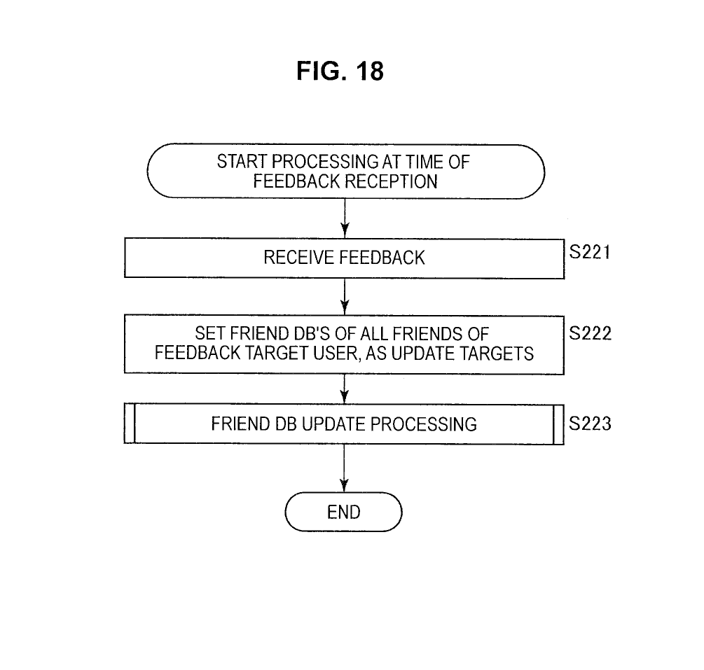

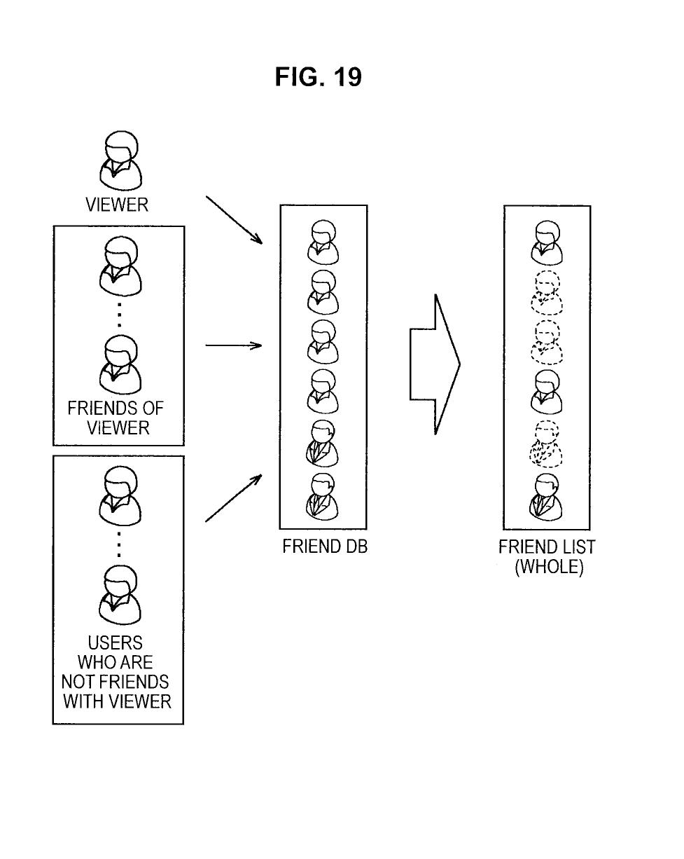

Next, with reference to FIG. 18 and FIG. 19, an explanation is given to the second alternation example of processing at the time of feedback reception instead of FIG. 9 described above.

In step S221, by the processing similar to that in step S1 in FIG. 9, information related to a feedback transmitted from the client 12 is received.

In step S222, the friend DB generation unit 82 sets the friend DB's of all friends of the feedback target user as update targets. Among these, a friend DB of the user who gives a feedback is included.

In step S223, with reference to FIG. 10, the friend DB generation unit 82 performs the above friend DB update processing on the friend DB set as the update target, and the processing at the time of feedback reception is terminated.

By this means, for example, in a case where a user A gives a feedback to a comment of a user B, first, the like score and dislike score of the user B in the friend DB's of all friends (including the user A) of the user B are updated.

Therefore, the friend DB of each user is updated based on feedbacks given by all users. That is, evaluations of all of users including the user A with respect to the comment of each friend of the user A are reflected to the like score and dislike score of the friend DB of the user A.

Therefore, as illustrated in FIG. 19, the viewer's friend list is generated from the friend DB's updated based on feedbacks given from all users to viewer's friends, where all the users include the viewer, the viewer's friends and users who are not friends with the viewer. As a result, the user (i.e. the presentation target user) included in the friend list is a friend with a high evaluation within a range of all users among the viewer's friends, to be more specific, a friend with a high possibility (or success rate) that the users of the social service generally give positive feedbacks to a comment.

Therefore, by extracting a comment based on this friend list and presenting it to the viewer, the comment decided to be beneficial from a standpoint of all users including the viewer, is presented to the viewer among comments of viewer's friends. By this means, compared with the case based on only viewer's standpoint, it is possible to preferentially present a beneficial comment with respect to various wider topics to the viewer.

Also, in the following, in a case where it is requested to distinguish the friend list generated by the procedure illustrated in FIG. 19 from a friend list generated by other methods, it is referred to as “friend list (whole).”

### [Alternation Example of Friend Comment Filtering Processing]

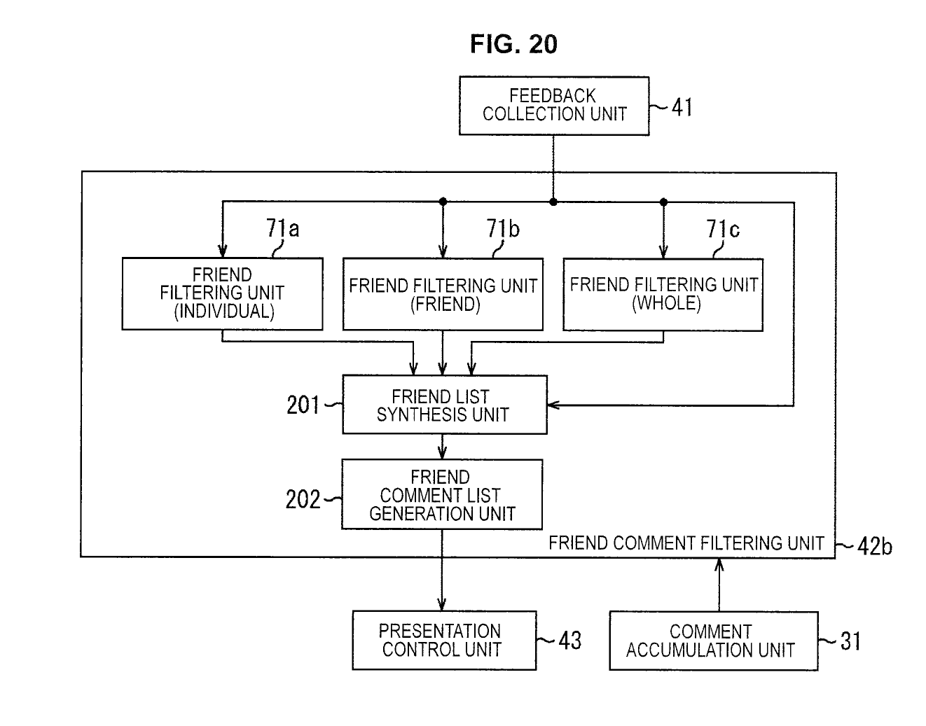

Next, with reference to FIG. 20 to FIG. 23, an explanation is given to an alternation example of the friend comment filtering processing in step S102 in FIG. 11 described above.

### (Alternation Example of Friend Comment Filtering Unit)

FIG. 20 is a block diagram illustrating a functional configuration example of the friend comment filtering unit 42b which is an alternation example of the friend comment filtering unit 42 in FIG. 5.

The friend comment filtering unit 42b is formed including friend filtering units 71a to 71c, a friend list synthesis unit 201 and a friend comment list generation unit 202.

The friend filtering units 71a to 71c have the configuration similar to that of the friend filtering unit 71 in FIG. 5, and generate a friend list with respect to the viewer based on each user's feedback supplied from the feedback collection unit 41.

Here, the friend filtering units 71a to 71c generate the friend lists from different viewpoints. Specifically, the friend filtering unit 71a performs processing based on the flowchart in above FIG. 9 in the case of receiving the feedback from each user, and, based on a friend DB 91 acquired as a result, generates a friend list. That is, the friend filtering unit 71a generates a friend list (individual) with respect to the viewer by the method illustrated in FIG. 14 described above. Subsequently, the friend filtering unit 71a supplies the generated friend list (individual) to the friend list synthesis unit 201.

The friend filtering unit 71b performs processing based on the flowchart in above FIG. 16 in the case of receiving the feedback from each user, and, based on a friend DB 91 acquired as a result, generates a friend list. That is, the friend filtering unit 71b generates the friend list (friend) to the viewer by the method illustrated in FIG. 17 described above. Subsequently, the friend filtering unit 71b supplies the generated friend list (friend) to the friend list synthesis unit 201.

The friend filtering unit 71c performs processing based on the flowchart in above FIG. 18 in the case of receiving the feedback from each user, and, based on a friend DB 91 acquired as a result, generates a friend list. That is, the friend filtering unit 71c generates a friend list (whole) with respect to the viewer by the method illustrated in FIG. 19 described above. Subsequently, the friend filtering unit 71c supplies the generated friend list (whole) to the friend list synthesis unit 201.

The friend list synthesis unit 201 synthesizes three kinds of friend lists supplied from the friend filtering units 71a to 71c, and generates a synthesis friend list. The friend list synthesis unit 201 supplies the generated synthesis friend list to the friend comment list generation unit 202.

The friend comment list generation unit 202 extracts, from the viewer's friend comment DB 51, a comment presented to the viewer among comments sent by a presentation target user included in the synthesis friend list. The friend comment list generation unit 202 generates a friend comment list including the extracted comment, and supplies the generated friend comment list to the presentation control unit 43.

### (Configuration Example of Friend List Synthesis Unit 201)

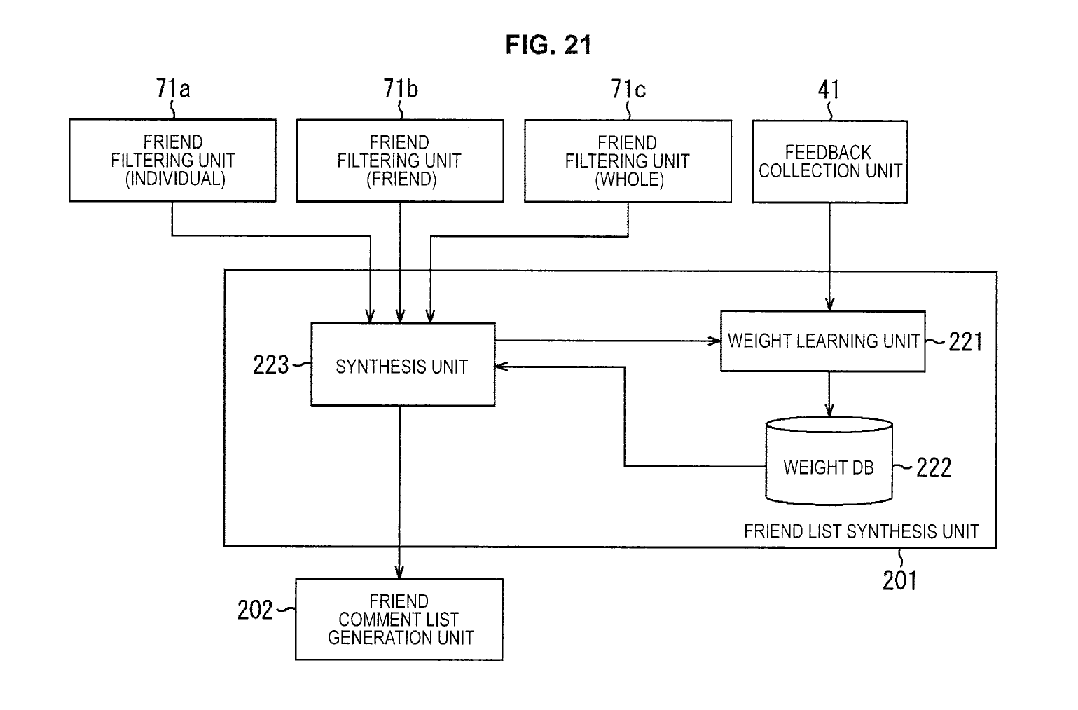

FIG. 21 is a block diagram illustrating a functional configuration example of the friend list synthesis unit 201. The friend list synthesis unit 201 is formed including a weight learning unit 221, a weight DB 222 and a synthesis unit 223.

The weight learning unit 221 learns weights used to synthesize three kinds of friend lists described above, for each user, based on each user's feedback supplied from the feedback collection unit 41. The weight learning unit 221 stores the weights with respect to each user, which are acquired as a result of learning, in the weight DB 222.

The synthesis unit 223 synthesizes three kinds of friend lists supplied from the friend filtering units 71a to 71c using the weights stored in the weight DB 222, and generates a synthesis friend list. The synthesis unit 223 supplies the generated synthesis friend list to the friend comment list generation unit 202 and the weight learning unit 221.

### (Alternation Example of Friend Comment Filtering Processing)

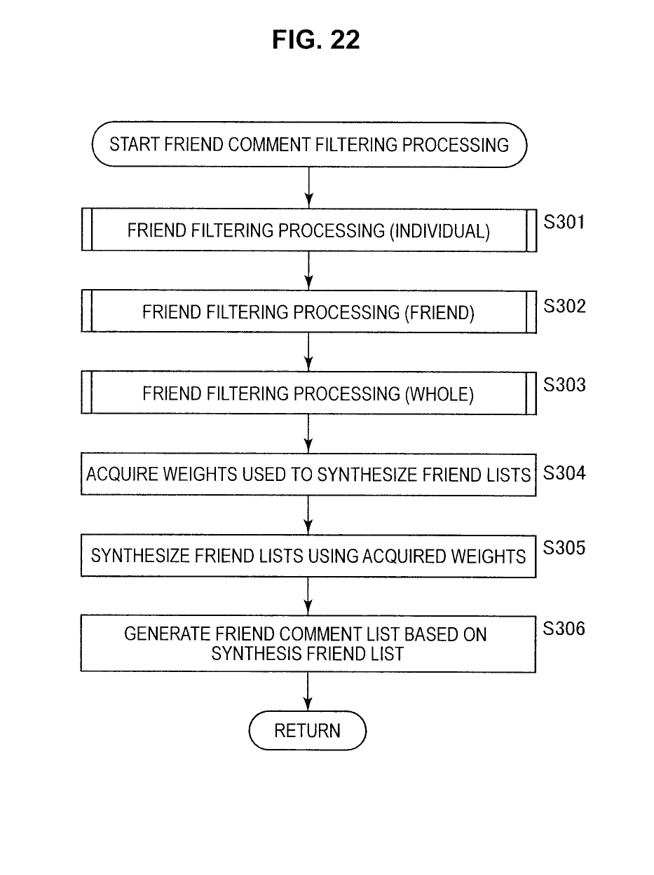

Next, with reference to the flowchart in FIG. 22, an explanation is given to an alternation example the friend comment filtering processing in step S102 in FIG. 11.

In step S301, the friend filtering unit 71a performs the friend filtering processing according to the flowchart in FIG. 13 or FIG. 15 described above. By this means, the friend list (individual) with respect to the viewer is generated and supplied from the friend filtering unit 71a to the synthesis unit 223.

In step S302, the friend filtering unit 71b performs the friend filtering processing according to the flowchart in FIG. 13 or FIG. 15 described above. By this means, the friend list (friend) with respect to the viewer is generated and supplied from the friend filtering unit 71b to the synthesis unit 223.

In step S303, the friend filtering unit 71c performs the friend filtering processing according to the flowchart in FIG. 13 or FIG. 15 described above. By this means, the friend list (whole) with respect to the viewer is generated and supplied from the friend filtering unit 71c to the synthesis unit 223.

In step S304, the synthesis unit 223 acquires weights used to synthesize the friend lists. That is, the synthesis unit 223 acquires the weights for the viewer among weights stored in the weight DB 222.

In step S305, the synthesis unit 223 synthesizes the friend lists using the acquired weights. For example, when the expectation values in the friend list (individual), friend list (friend) and friend list (whole) of a certain presentation target user are Ea, Eb, and Ec, the synthesis unit 223 calculates an expectation value ΣE with respect to the presentation target user by weighting and adding them as illustrated in following Expression (6).

ΣE=α·Ea+β·Eb+γ·Ec (6)

Here, “α” is a weight with respect to the friend list (individual), “β” is a weight with respect to the friend list (friend) and “γ” is a weight with respect to the friend list (whole). As described later, these weights α to γ are calculated by the learning processing every user.

Here, for example, regarding a presentation target user included only in a partial friend list, the expectation value in a friend list that doesn't contain the user is set to 0 in Expression (6). For example, in a case where a certain presentation target user is included in the friend list (individual) and the friend list (friend) and is not included in the friend list (whole), the expectation value Ec with respect to the user is set to 0 in Expression (6).

Subsequently, the synthesis unit 223 calculates expectation values EE with respect to all of presentation target users included in at least one of three kinds of friend lists.

Next, for example, the synthesis unit 223 extracts a predetermined number of presentation target users in order from the one with the highest expectation value ΣE. Alternatively, for example, the synthesis unit 223 extracts presentation target users with expectation values ΣE equal to or greater than a predetermined threshold. Subsequently, the synthesis unit 223 generates a synthesis friend list including: the extracted presentation target users; their expectation values ΣE; and the types of friend lists including the extracted presentation target users, and supplies it to the friend comment list generation unit 202 and the weight learning unit 221.

In step S306, the friend comment list generation unit 202 generates a friend comment list based on the synthesis friend list in the same way as the processing in step S123 in FIG. 12. The friend comment list generation unit 202 supplies the generated friend comment list to the presentation control unit 43.

After that, the friend comment filtering processing is terminated.

By this means, among comments of viewer's friends, a comment is presented to the viewer, where the comment is decided to be beneficial based on viewer's standpoint, standpoints of the viewer's friends including the viewer or all users' viewpoints. Therefore, compared with a case based on only one kind of standpoint, it is possible to preferentially present a beneficial comment with respect to various wider topics to the viewer.

### (Friend List Synthesis Weight Learning Processing)

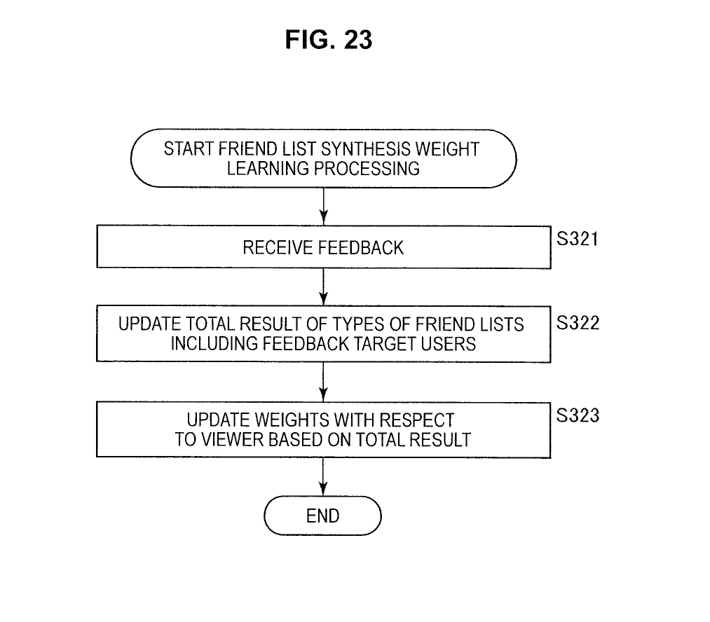

Next, with reference to the flowchart in FIG. 23, an explanation is given to friend list synthesis weight learning processing performed by the friend list synthesis unit 201. Here, for example, this processing is performed every time the viewer gives a feedback to a comment presented in the viewer's client 12 by the processing in step S103 in FIG. 11.

In step S321, the feedback collection unit 41 receives information related to a feedback transmitted from the client 12, through the communication unit 31. The feedback collection unit 41 supplies information related to the received feedback to the weight learning unit 221.

Also, although a detailed explanation is omitted, information related to the received feedback at this time is supplied to the friend filtering units 71a to 71c and the above processing is performed with reference to FIG. 9, FIG. 16 and FIG. 18.

In step S322, the weight learning unit 221 updates the total result with respect to the types of friend lists including the feedback target users. Specifically, for each user, the weight learning unit 221 tallies in which of the friend list (individual), the friend list (friend) and the friend list (whole) one user who sent a comment to which the other user gives a feedback (i.e. feedback target user) is included, and the weight learning unit 221 stores the result in the weight DB 222. For example, this total result is separately tallied for the positive feedback and the negative feedback.

Here, this total result indirectly indicates the total result of an evaluation type used to extract the feedback target user of each user. That is, it indirectly indicates by which of viewer's evaluation, evaluation within a range of viewer's friends and evaluation within a range of all users the feedback target user of each user is extracted.

Subsequently, the weight learning unit 221 specifies the type of a friend list including the feedback target user of the current viewer, based on the synthesis friend list supplied from the synthesis unit 223, and updates the above total result with respect to the viewer.

In step S323, the weight learning unit 221 updates weights with respect to the viewer based on the total result. Specifically, the weight learning unit 221 updates the weights α, β, and γ of above Expression (6) used for the viewer, based on the updated total result. Although the setting method of the values of the weights α, β, and γ is not specifically limited, for example, higher values are set to the weights with respect to a friend list that is highly likely to include the user who sends a comment to which the viewer gives a positive feedback.

For example, in a case where the probability including the user who sent a comment to which the viewer gave a positive feedback in the past is in the relationship of friend list (individual)>friend list (friend)>friend list (whole), they are set to α>β>γ.

Here, taking into consideration even the probability including the user who sends a comment to which the viewer gives a negative feedback, a smaller value may be set to a weight with respect to a friend list in which the probability is high.

After that, the friend list synthesis weight learning processing is terminated.

By this means, the presentation target user is preferentially extracted from a friend list with a high probability of including the user who sends a comment to which the viewer gives a positive feedback. As a result, it is possible to present a more beneficial comment for the viewer.

Here, in the above explanation, although an example of synthesizing three kinds of friend lists of the friend list (individual), the friend list (friend) and the friend list (whole) has been illustrated, it may be possible to synthesize only two arbitrary kinds of those. In a case where two kinds of friend lists are synthesized, it is possible to omit a friend filtering unit corresponding to an unused friend list among the friend filtering units 71a to 71c in FIG. 20. Also, it is possible to omit processing corresponding to the unused friend list among the processing in steps S301 to S303 in FIG. 22.

Therefore, as the friend comment filtering processing, seven kinds of processing are broadly provided depending on the type of a used friend list. That is, there are totally seven kinds of processing: three kinds in the case of using each of three kinds of friend lists alone; three kinds in the case of using two of three kinds of friend lists; and one kind in the case of using all of three kinds of friend lists.

### 3. Second Embodiment

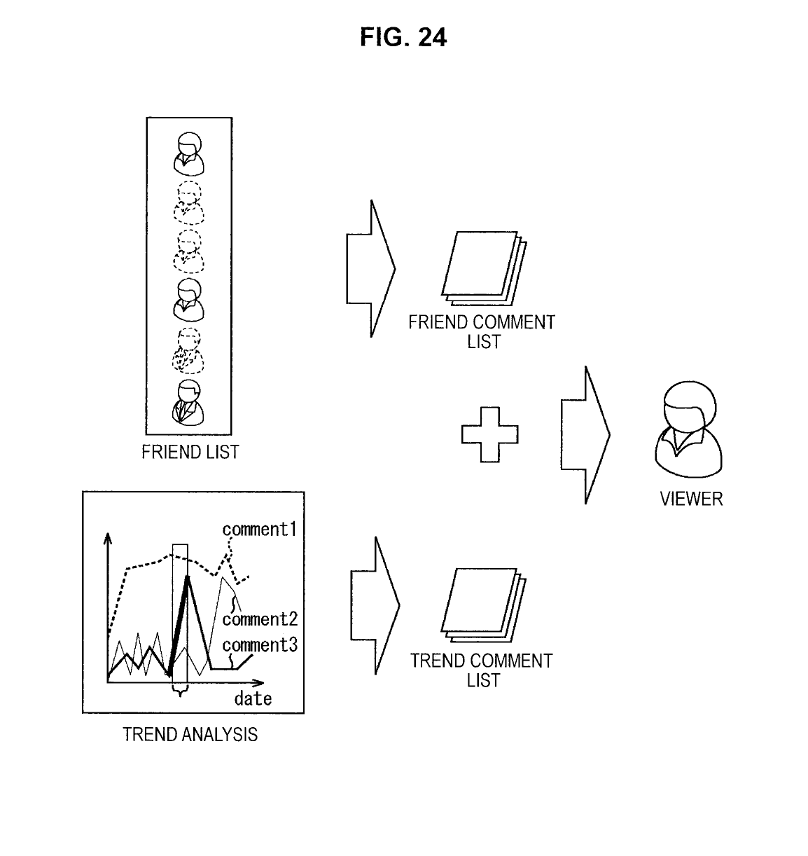

Next, with reference to FIG. 24 to FIG. 31, the second embodiment of the present disclosure is explained.

### [Outline of Comment Filtering Function According to the Second Embodiment]

First, with reference to FIG. 24, an explanation is given to an outline of a comment filtering function realized in the second embodiment of the present disclosure.

This comment filtering function performs a trend analysis of extracting a comment whose immediate evaluation is greatly changed in viewer's friends. By this trend analysis, for example, a comment related to a seasonal topic attracting a lot of attention in viewer's friends (e.g. a change in friend's recent situation) is extracted. Subsequently, in addition to the above friend comment list, a trend comment list including the comment extracted by the trend analysis is generated, the two kinds of comment lists are synthesized and a comment included in the synthesized comment list is presented to the viewer.

### [Configuration Example of Server 11b]

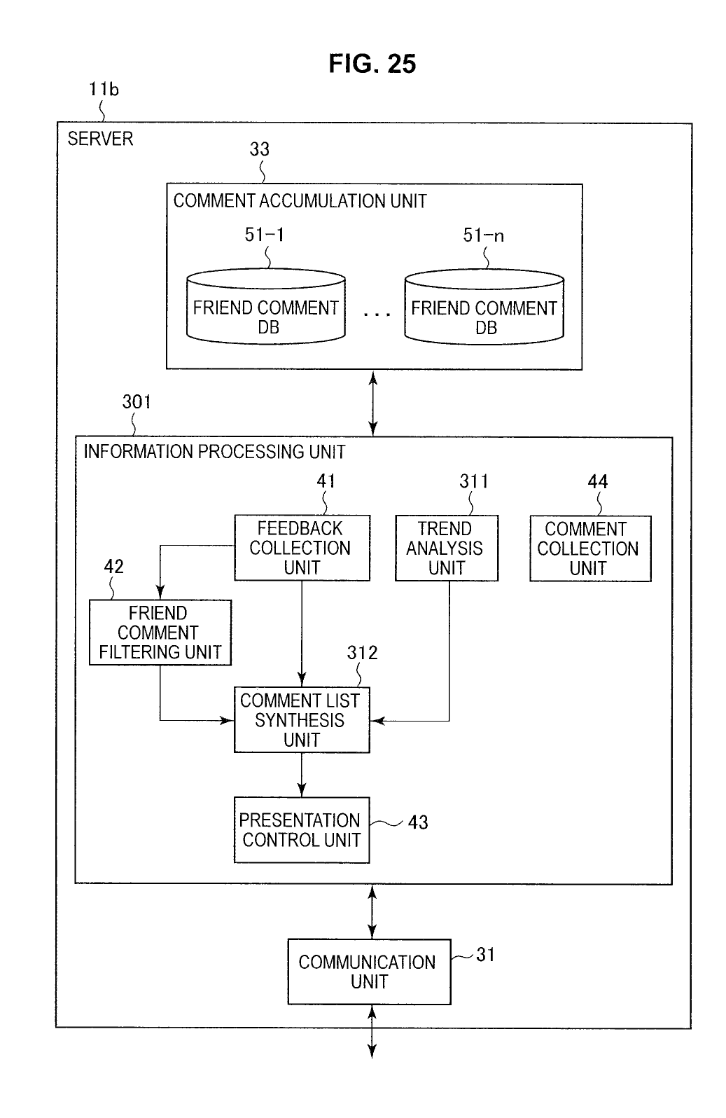

FIG. 25 is a block diagram illustrating a functional configuration example of a server 11b which is the second embodiment of the server 11 in the information processing system 1. Here, FIG. 25 illustrates a configuration example of parts to perform processing chiefly related to comment presentation among functions of the server 11b. Also, in the drawing, the same reference numerals are assigned to parts corresponding to FIG. 3, and, regarding parts with the same processing, their explanation is repeated and therefore omitted.

The server 11b and the server 11a in FIG. 3 are common in that the communication unit 31 and the comment accumulation unit 33 are included, and they are different in that an information processing unit 301 is provided instead of the information processing unit 32. Further, the information processing unit 301 and the information processing unit 32 are common in that the feedback collection unit 41, the friend comment filtering unit 42, the presentation control unit 43 and the comment collection unit 44 are included, and they are different in that a trend analysis unit 311 and a comment list synthesis unit 312 are added.

Here, as the friend comment filtering unit 42, it is possible to adopt any of the friend comment filtering unit 42a in FIG. 5 and the friend comment filtering unit 42b in FIG. 20.

By performing the above trend analysis, the analysis unit 311 generates a trend comment list and supplies the generated trend comment list to the comment list synthesis unit 312.

The comment list synthesis unit 312 synthesizes the friend comment list and the trend comment list and generates a synthesis comment list. Subsequently, the comment list synthesis unit 312 supplies the generated synthesis comment list to the presentation control unit 43.

### [Configuration Example of Trend Analysis Unit 311]

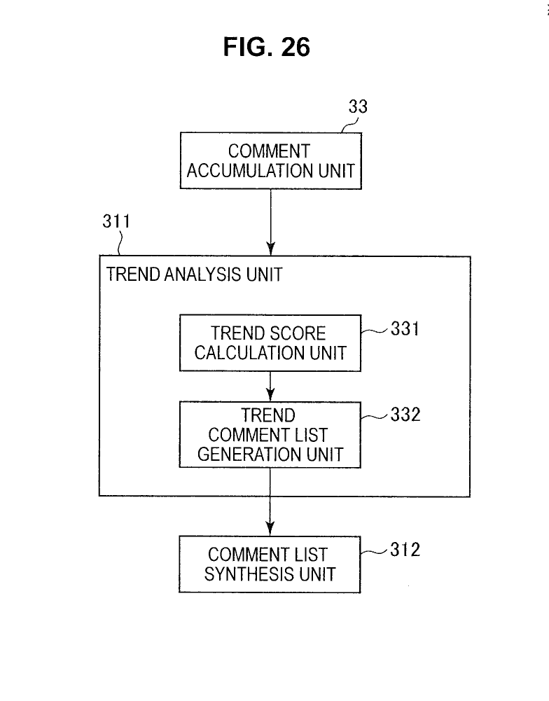

FIG. 26 is a block diagram illustrating a functional configuration example of the trend analysis unit 311. The trend analysis unit 311 is formed including a trend score calculation unit 331 and a trend comment list generation unit 332.

The trend score calculation unit 331 calculates a trend score indicating the level of a change in the evaluation with respect to each comment sent by viewer's friend, and supplies the calculation result to the trend comment list generation unit 332.

The trend comment list generation unit 332 extracts a comment with a high trend score from the viewer's friend comment DB 51 among comments sent by the viewer's friend. The trend comment list generation unit 332 generates a trend comment list including the extracted comment and supplies the generated trend comment list to the comment list synthesis unit 312.

### [Configuration Example of Comment List Synthesis Unit 312]

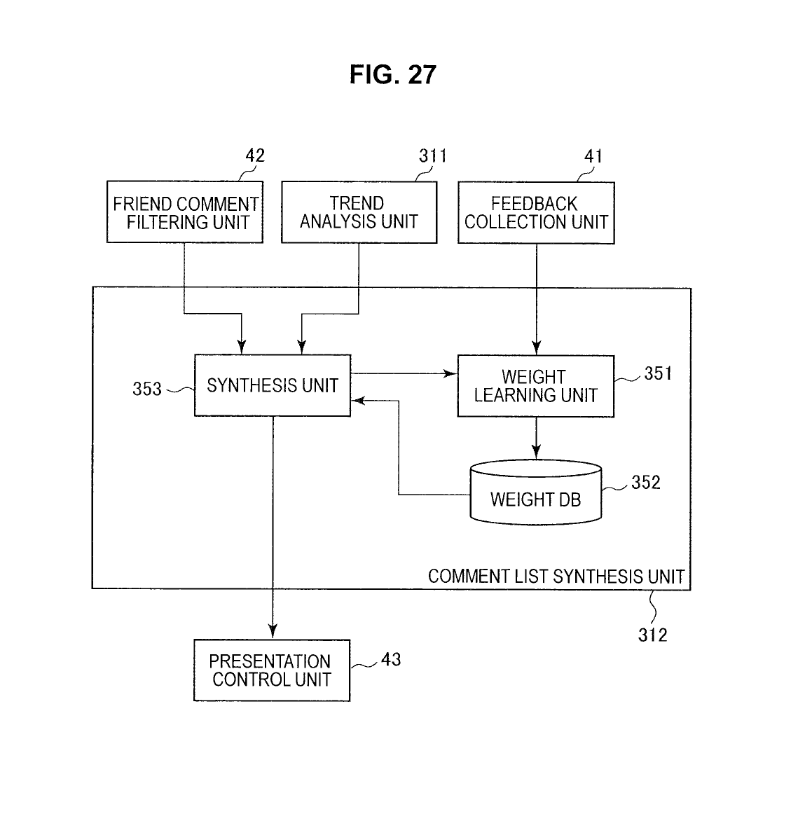

FIG. 27 is a block diagram illustrating a functional configuration example of the comment list synthesis unit 312. The comment list synthesis unit 312 is formed including a weight learning unit 351, a weight DB 352 and a synthesis unit 353.

The weight learning unit 351 learns weights used to synthesize the friend comment list and the trend comment list, for each user, based on each user's feedback supplied from the feedback collection unit 41. The weight learning unit 351 stores the weights with respect to each user, which are acquired as a result of learning, in the weight DB 352.

The synthesis unit 353 synthesizes the friend comment list supplied from the friend comment filtering unit 42 and the trend comment list supplied from the trend analysis unit 311, using the weights stored in the weight DB 352, and generates a synthesis comment list. The synthesis unit 223 supplies the generated synthesis comment list to the presentation control unit 43 and the weight learning unit 351.

### [Processing of Server 11b]

Next, an explanation is given to the processing in the server 11b.

In the server 11b, in a case where a feedback is received from the client 12, similar to the server 11a, at least one of the above processing is performed with reference to FIG. 9, FIG. 16 or FIG. 18. Here, processing to be performed varies depending on the type of the friend filtering unit 71 included in the server 11b.

Also, in a case where the server 11b has two or more kinds of friend filtering units 71, when a feedback is received from the client 12, the above friend list synthesis weight learning processing is performed with reference to FIG. 23.

### (Comment Presentation Processing)

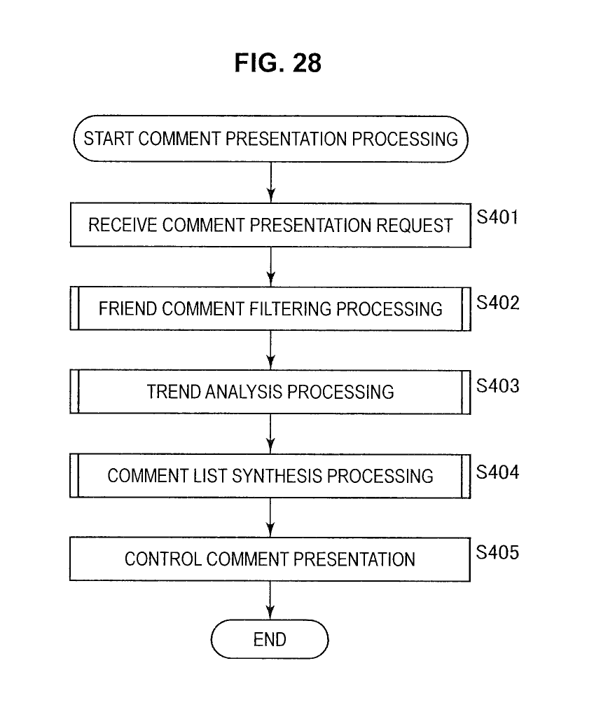

Next, with reference to the flowchart in FIG. 28, an explanation is given to the comment presentation processing performed in the server 11b. Here, for example, this processing starts at the time when: an arbitrary user (e.g. viewer) of the social service performs an operation of displaying a friend's comment in the client 12; and, as a result, a request for comment presentation is transmitted from the client 12 to the server 11b through the network 13.

In step S401, the friend comment filtering unit 42 and the trend analysis unit 311 receive the comment presentation request transmitted from the client 12, through the communication unit 31.

In step S402, the above friend comment filtering processing is performed with reference to FIG. 12 or FIG. 22. By this means, a friend comment list is generated by the friend comment filtering unit 42 and supplied to the synthesis unit 353 of the comment list synthesis unit 312.

### (Trend Analysis Processing)

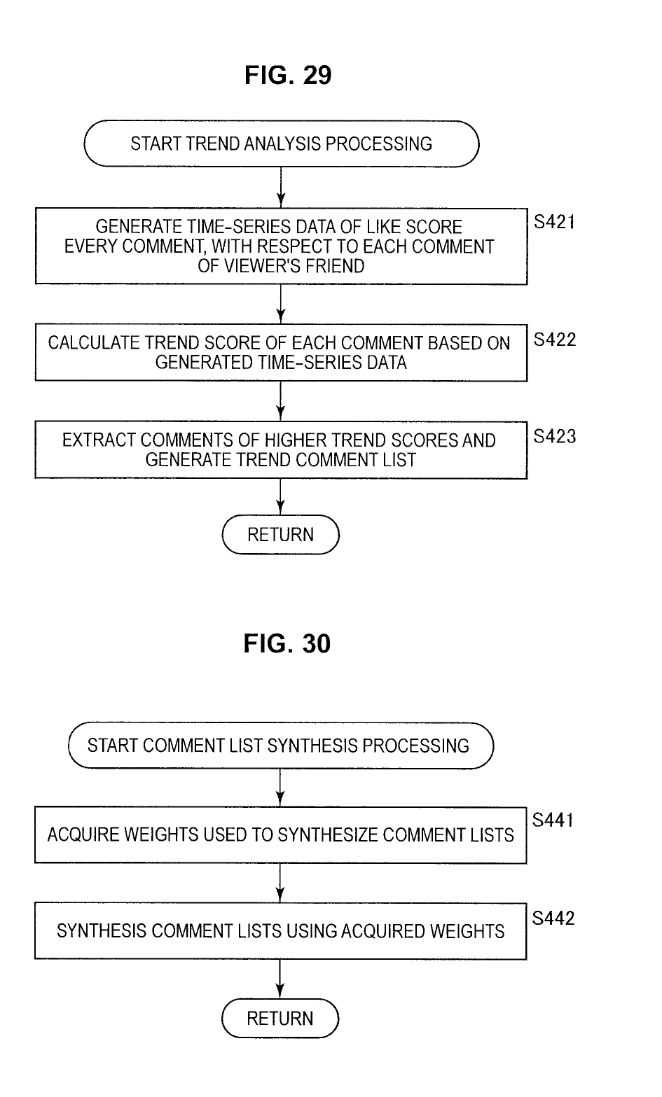

In step S403, the trend analysis unit 311 performs the trend analysis processing. Here, with reference to the flowchart in FIG. 29, an explanation is given to details of the trend analysis processing.

In step S421, the trend score calculation unit 331 generates time-series data of the like score of each comment, for each comment of the viewer's friend. For example, the trend score calculation unit 331 generates time-series data indicating an increment every like score, using the viewer's friend comment DB 51.

In step S422, the trend score calculation unit 331 calculates the trend score of each comment based on the generated time-series data. For example, the trend score calculation unit 331 calculates a trend score S(n) on reference date “n” with respect to a certain comment, by following Expressions (7) to (9).

$$\begin{matrix}S ( n ) = {( \frac{{σ}^{2} ( n )}{{σ}^{2} ( n - 1 )} )}^{1 / 2} & ( 7 ) \\ {σ}^{2} ( n ) = \frac{1}{N} {\sum }_{t = n - N + 1}^{n} \{ {( x ( t ) - μ ( n ) \}}^{2} & ( 8 ) \\ μ ( n ) = \frac{1}{N} {\sum }_{t = n - N + 1}^{n} x ( t ) & ( 9 )\end{matrix}$$

Here, X(t) (t=1, 2, . . . , n) indicates time-series data of an increment of the like score with respect to the target comment. Also, μ(n) indicates the moving average of time-series data x(t) in a period of N days between reference date “n” and the day N−1 days before “n.” Also, σ2(n) indicates the movement dispersion of time-series data x(t) in a period of N days between reference date “n” and the day N−1 days before “n.”

Therefore, the trend score S(n) indicates the ratio of movement deviation √σ²(n) in a period of N days between reference date “n” and the day N−1 days before “n,” to movement deviation √σ²(n−1) in a period of N days between “n−1” and the day N−1 days before “n−1.” Therefore, the trend score S(n) becomes higher with respect to a comment with a larger change in the increment of the like score on reference date “n” compared with the days before reference date “n,” in other words, with respect to a comment with a larger change in the amount of given positive feedbacks.

For example, in a case where reference date “n” is set to yesterday, the trend score S(n) illustrates the ratio of movement deviation √σ²(n) in a period of immediate N days to movement deviation √σ²(n−1) in a period of N days between “n−1” and the day N−1 days before “n−1.” Therefore, for example, the trend score S(n) becomes higher with respect to a comment in which the amount of given positive feedbacks rapidly increased yesterday compared with the day before yesterday. As a result, for example, the trend score S(n) becomes higher with respect to a comment related to a seasonal topic attracting a lot of attention in viewer's friends.

The trend score calculation unit 331 calculates the trend score of each comment sent by viewer's friend. At this time, it is not requested to calculate the trend scores with respect to all comments of the viewer's friend, and only new comments sent within an immediate predetermined period may be treated.

Subsequently, the trend score calculation unit 331 supplies the trend score calculation result to the trend comment list generation unit 332.

Also, in the above explanation, although an example has been illustrated where a trend score is calculated based on the time-series data in units of days, for example, it is also possible to change the units to calculate the time-series data, into units of weeks, hours, minutes, and so on.

Also, the trend score is not requested to be calculated based on the ratio between the movement deviation in a reference period and the movement deviation in the previous period, and, for example, it may be possible to calculate the trend score based on the ratio between the movement deviation in a reference period and the movement deviation in a period two or more periods before the reference period.

Further, for example, it may be possible to calculate the trend score taking into consideration not only an increment of the like score but also an increment of the dislike score. By this means, for example, in a case where the reference date “n” is set to yesterday, the trend score becomes higher with respect to a comment in which the amount of given positive/negative feedbacks rapidly increased yesterday compared with the day before yesterday. Therefore, the trend score becomes higher with respect to a comment related to a seasonal topic attracting a lot of attention, regardless of whether it is favorably responded to by viewer's friends.

In step S423, the trend comment list generation unit 332 extracts comments with higher trend scores and generates a trend comment list. For example, the trend comment list generation unit 332 extracts a predetermined number of comments in order from the one with the highest trend score, among comments of viewer's friend. Alternatively, for example, the trend comment list generation unit 332 extracts comments with trend scores equal to or higher than a predetermined threshold, among comments of viewer's friend. Subsequently, the trend comment list generation unit 332 generates a trend comment list including the extracted comments and their trend scores, and supplies it to the comment list synthesis unit 312.

After that, the trend analysis processing is terminated.

Returning to FIG. 28, in step S404, the comment list synthesis unit 312 performs comment list synthesis processing. Here, with reference to the flowchart in FIG. 30, the comment list synthesis processing is explained in detail.

In step S441, the synthesis unit 353 acquires weights used to synthesize comment lists. That is, the synthesis unit 353 acquires weights for the viewer among weights stored in the weight DB 352.

In step S442, the synthesis unit 353 synthesizes the comment lists using the acquired weights. For example, when the expectation value with respect to a certain comment in the friend comment list is E and the trend score with respect to the comment in the trend comment list is S, by weighting and adding them in following Expression (10), the synthesis unit 353 calculates a decision value V with respect to the comment.

V=W1·E+W·S (10)

Here, W1 is a weight with respect to the friend comment list and W2 is a weight with respect to the trend comment list. These weights W1 and W2 are calculated by the learning processing every user, as described later.

Here, it is preferable that expectation value E and trend score S are normalized to substantially the same value before they are weighted and added. Also, regarding a comment included only in one comment list, for example, the expectation value E or the trend score S is set to 0 with respect to a comment list that doesn't include the comment.

Subsequently, the synthesis unit 353 calculates decision values V with respect to all of comments included in at least one of two kinds of comment lists.

Next, for example, the synthesis unit 353 extracts a predetermined number of comments in order from the one with the highest decision value V. Alternatively, for example, the synthesis unit 353 extracts comments with decision values V equal to or greater than a predetermined threshold. Subsequently, the synthesis unit 353 generates a synthesis comment list including: the extracted comments; their decision values V; and the types of comment lists including the extracted comments, and supplies it to the presentation control unit 43 and the weight learning unit 351.

After that, the comment list synthesis processing is terminated.

Returning to FIG. 28, in step S405, the presentation control unit 43 controls the presentation of comments. Specifically, the presentation control unit 43 generates presentation control data to present the comments included in the synthesis comment list. Subsequently, the presentation control unit 43 transmits the generated presentation control data to the viewer's client 12 through the communication unit 31 and the network 13.

The output control unit 102 of the viewer's client 12 receives the presentation control data through the communication unit 101. The output control unit 102 arranges the comments included in the synthesis comment list in order from the latest one, for example, based on the presentation control data, and displays the results in the output unit 103.

After that, the comment presentation processing is terminated.

By this means, not only a friend's comment which is highly evaluated by the viewer or the like but also, for example, a comment related to a seasonal topic attracting a lot of attention in viewer's friends can be presented to the viewer. Therefore, for example, friend's comments that are not usually presented too much are sometimes presented, and it is possible to give a new chance to build a friendship to the viewer. Also, for example, it is possible to reliably check a seasonal topic attracting a lot of attention among friends estranged from the viewer.

### (Comment List Synthesis Weight Learning Processing)

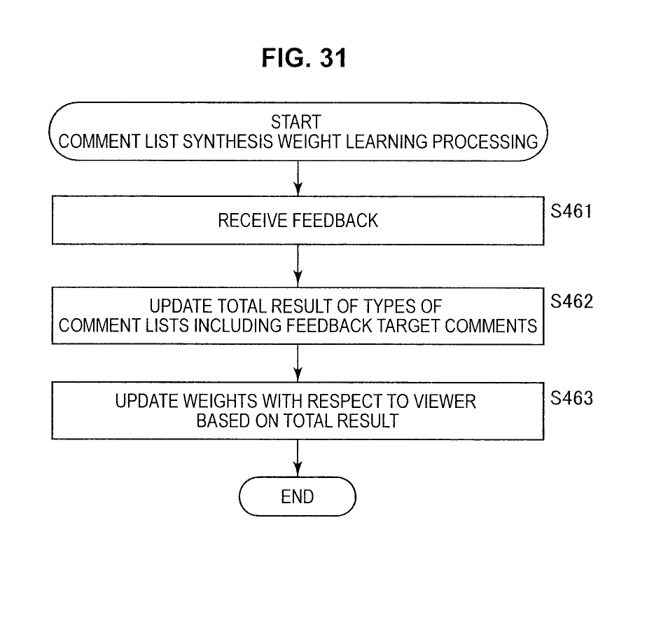

Next, with reference to the flowchart in FIG. 31, an explanation is given to comment list synthesis weight learning processing performed by the comment list synthesis unit 312. Here, this processing is performed every time a feedback is given to a comment presented in the viewer's client 12 by the processing in step S405 in FIG. 28.

In step S461, the feedback collection unit 41 receives information related to a feedback transmitted from the client 12, through the communication unit 31. The feedback collection unit 41 supplies the received information related to the feedback to the weight learning unit 351.

In step S462, the weight learning unit 351 updates the total result with respect to the types of comment lists including feedback target comments. Specifically, for each user, the weight learning unit 351 tallies in which of the friend comment list and the trend comment list a comment to which the user gives a feedback (i.e. feedback target comment) is included, and the weight learning unit 351 stores the result in the weight DB 352. For example, this total result is separately tallied for the positive feedback and the negative feedback.

Here, this total result indirectly indicates whether the feedback target comment of each user is extracted by the friend comment filtering unit 42 or it is extracted by the trend analysis unit 311.

Subsequently, the weight learning unit 351 specifies the type of a comment list including the feedback target comment of the current viewer, based on the synthesis comment list supplied from the synthesis unit 353, and updates the above total result with respect to the viewer.

In step S463, the weight learning unit 351 updates weights with respect to the viewer based on the total result. Specifically, the weight learning unit 351 updates the weights W1 and W2 of above Expression (10) used for the viewer, based on the updated total result. Although the setting method of the values of the weights W1 and W2 is not specifically limited, for example, higher values are set to the weights with respect to a comment list that is highly likely to include a comment to which the viewer gives a positive feedback.

For example, in a case where the probability including a comment to which the viewer gave a positive feedback in the past is in the relationship of friend comment list>trend comment list, they are set such to W1>W2.

Here, taking into consideration even the probability including a comment to which the viewer gives a negative feedback, a larger value may be set to a weight with respect to a comment list with the high probability.

After that, the comment list synthesis weight learning processing is terminated.

By this means, a comment is preferentially extracted from a comment list with a high probability of including comments to which the viewer gives a positive feedback. As a result, it is possible to present a more beneficial comment for the viewer.

### 4. Third Embodiment

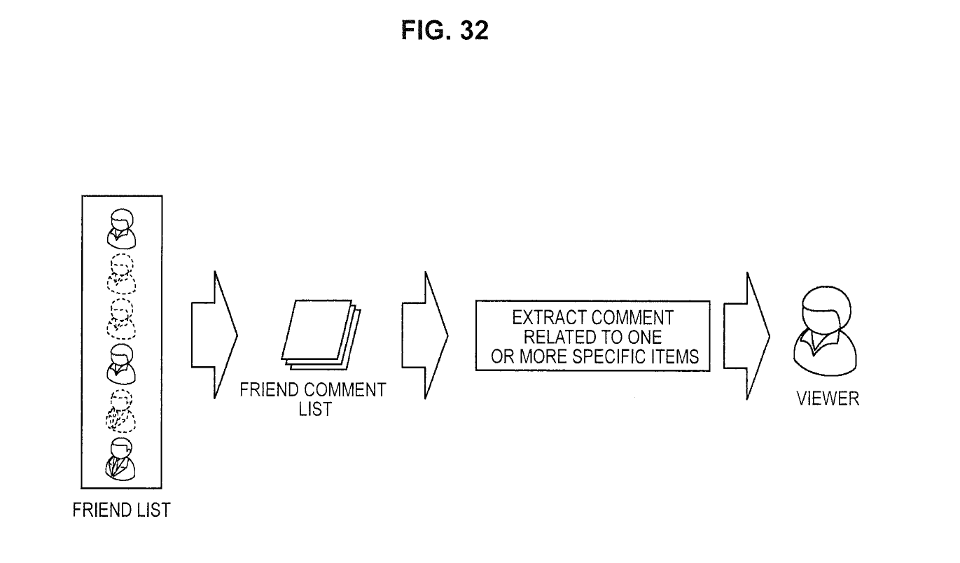

Next, with reference to FIG. 32 to FIG. 38, the third embodiment of the present disclosure is explained.

### [Outline of Comment Filtering Function According to the Third Embodiment]

First, with reference to FIG. 32, an explanation is given to an outline of a comment filtering function realized in the third embodiment of the present disclosure.

This comment filtering function extracts a comment recommended for the viewer, from a friend comment list, and presents it. Specifically, as a comment recommended for the viewer, only a comment related to one or more specific items is extracted.

Here, the type of the specific item is not especially limited as long as the item is an item suitable to be generally recommended to a person, and, for example, there are assumed various contents, commodities, services, activities, places, websites, topics, articles, persons, flora and fauna, foods, and so on. Also, a comment related to a more specific item is preferentially extracted compared to a comment related to a general item. For example, a comment related to Mt. Fuji which is more specific is preferentially extracted compared to a comment related to a general mountain.

Also, since it is a comment related to one or more specific items, the type of the item does not matter as long as it relates to a certain specific item. Further, the number of item types may be one, two or more. Further, two or more items of the same type may be included. Further, it does not matter whether the item is suitable for the viewer's preference.

### [Configuration Example of Server 11c]

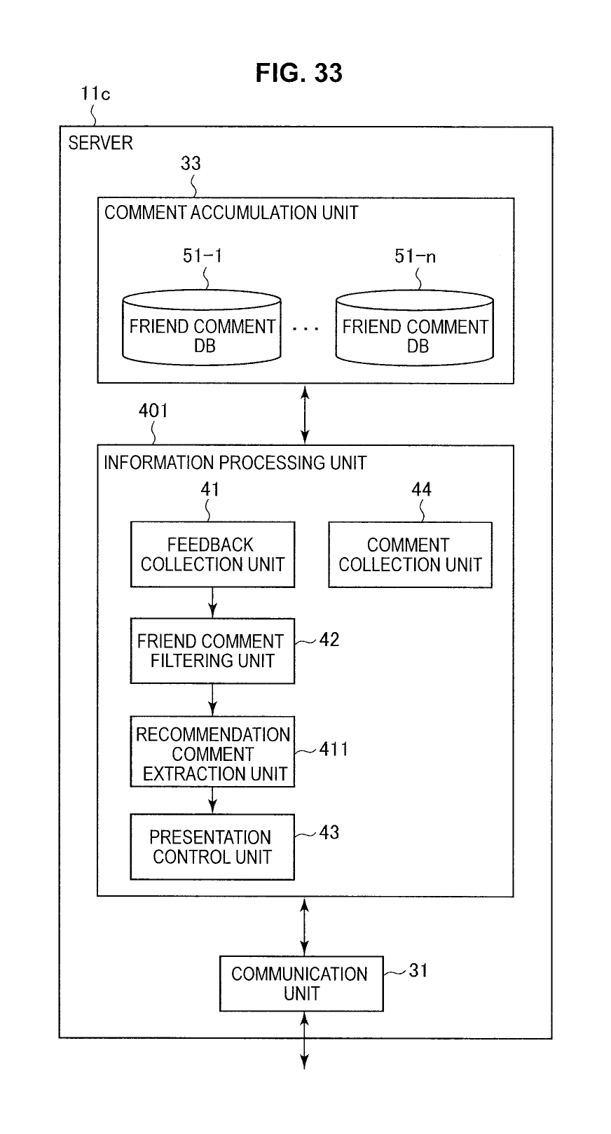

FIG. 33 is a block diagram illustrating a functional configuration example of a server 11c which is the third embodiment of the server 11 in the information processing system 1. Here, FIG. 33 illustrates a configuration example of parts to perform processing chiefly related to comment presentation among functions of the server 11c. Also, in the drawing, the same reference numerals are assigned to parts corresponding to FIG. 3, and, regarding parts with the same processing, their explanation is repeated and therefore omitted.

The server 11c and the server 11a in FIG. 3 are common in that the communication unit 31 and the comment accumulation unit 33 are included, and they are different in that an information processing unit 401 is provided instead of the information processing unit 32. Further, the information processing unit 401 and the information processing unit 32 are common in that the feedback collection unit 41, the friend comment filtering unit 42, the presentation control unit 43 and the comment collection unit 44 are included, and they are different in that a recommendation comment extraction unit 411 is added.

Here, as the friend comment filtering unit 42, it is possible to adopt any of the friend comment filtering unit 42a in FIG. 5 and the friend comment filtering unit 42b in FIG. 20.

The recommendation comment extraction unit 411 extracts a comment related to one or more specific items as a comment recommended to the viewer, from the friend comment list supplied from the friend comment filtering unit 42, and generates a recommendation comment list including the extracted comment. Subsequently, the recommendation comment extraction unit 411 supplies the generated recommendation comment list to the presentation control unit 43.

### [Configuration Example of Recommendation Comment Extraction Unit 411a]

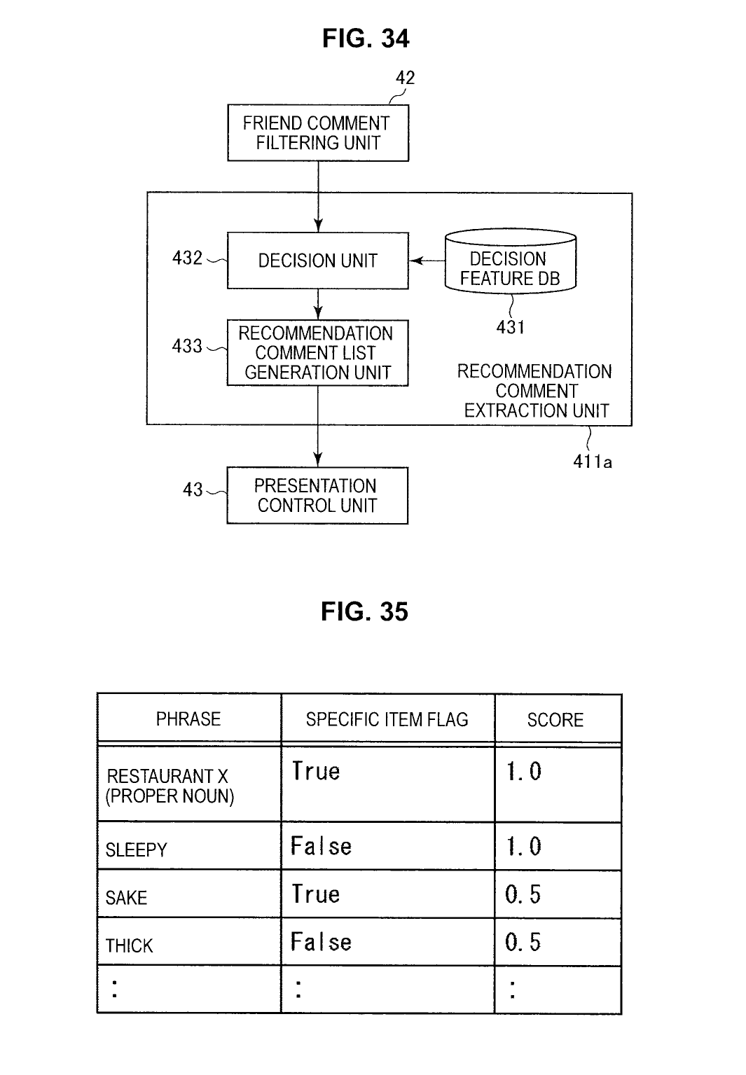

FIG. 34 is a block diagram illustrating a functional configuration example of the recommendation comment extraction unit 411a which is the first embodiment of the recommendation comment extraction unit 411. The recommendation comment extraction unit 411a is formed including a decision feature DB (database), 431, a decision unit 432 and a recommendation comment list generation unit 433.

The decision feature DB 431 is a database used to decide whether each phrase included in a comment relates to one or more specific items. As illustrated in FIG. 35, phrases assumed to be included in the comment are registered in the decision feature DB 431, and the specific item flag and the score are set to each phrase. Subsequently, the possibility that each phrase relates to a specific item is shown by combining the specific item flag and the score.

Specifically, in a case where the value of the specific item flag is “True,” there is a higher possibility that a corresponding phrase relates to a specific item as the score is higher, and there is a lower possibility that a corresponding phrase relates to a specific item as the score is lower. On the other hand, in a case where the value of the specific item flag is “False,” there is a higher possibility that a corresponding phrase does not relate to a specific item as the score is higher, and there is a lower possibility that a corresponding phrase does not relate to a general item as the score is lower. Here, generally, the proper noun is assumed that the score becomes high in a case where the value of the specific item flag is “True.”

Here, in a case where multiple languages are used in a social service, it is preferable to provide the decision feature DB for each language so as to support each language.

Using the decision feature DB 431, the decision unit 432 decides whether each comment in the friend comment list supplied from the friend comment filtering unit 42 relates to one or more specific items. The decision unit 432 supplies the decision result to the recommendation comment list generation unit 433 together with the friend comment list.

The recommendation comment list generation unit 433 extracts a comment related to one or more specific items from the friend comment list, based on the decision result in the decision unit 432, as a comment (hereafter referred to as “recommendation comment”) recommended to the viewer. The recommendation comment list generation unit 433 generates a recommendation comment list including the extracted recommendation comment and supplies it to the presentation control unit 43.

### [Processing in Server 11c]

Next, processing in the server 11c is explained.

In the server 11c, in a case where a feedback is received from the client 12, similar to the server 11a, at least one of the processing described above is performed with reference to FIG. 9, FIG. 16 or FIG. 18. Here, processing to be performed varies depending on the type of the friend filtering unit 71 included in the server 11c.

Also, in a case where the server 11c has two or more kinds of friend filtering units 71, when a feedback is received from the client 12, the above friend list synthesis weight learning processing is performed with reference to FIG. 23.

### (Comment Presentation Processing)

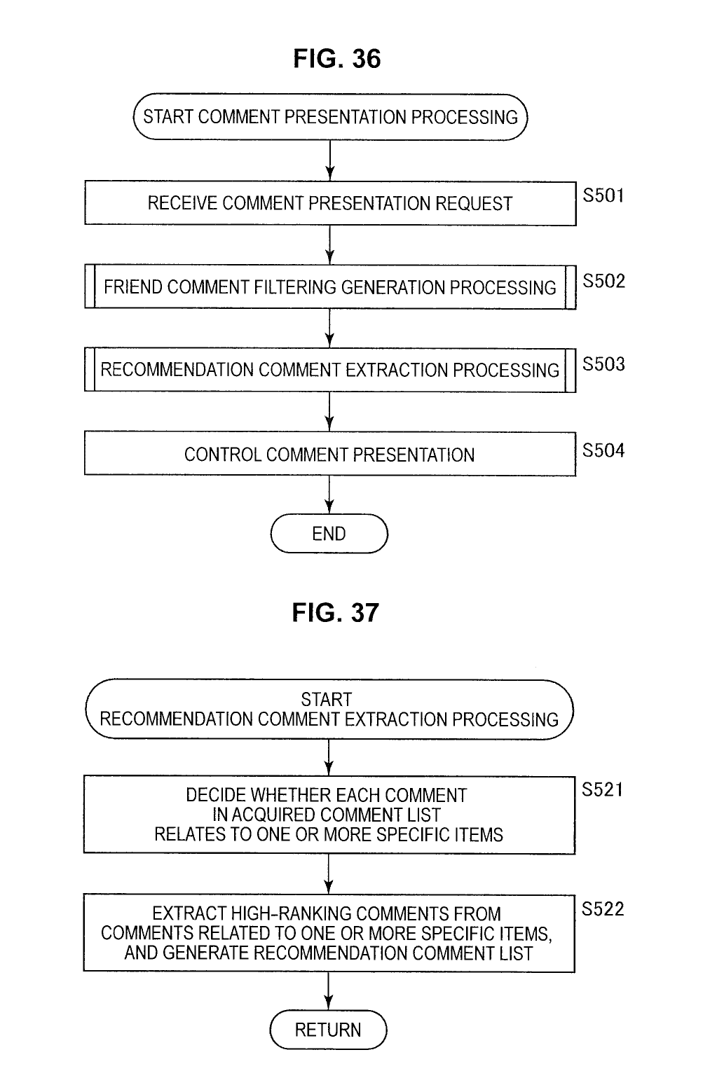

Next, with reference to the flowchart in FIG. 36, an explanation is given to the comment presentation processing performed in the server 11c. Here, for example, this processing starts at the time when: an arbitrary user (e.g. viewer) of the social service performs an operation of displaying a friend's comment in the client 12; and, as a result, a request for comment presentation is transmitted from the client 12 to the server 11c through the network 13.

In step S501, the friend comment filtering unit 42 receives the comment presentation request transmitted from the client 12, through the communication unit 31.

In step S502, the above friend comment filtering processing is performed with reference to FIG. 12 or FIG. 22. By this means, the friend comment list is generated by the friend comment filtering unit 42 and supplied to the decision unit 432 of the recommendation comment extraction unit 411a.

In step S503, the recommendation comment extraction unit 411a performs recommendation comment extraction processing. Here, with reference to the flowchart in FIG. 37, the recommendation comment extraction processing is explained in detail.

In step S521, the decision unit 432 decides whether each comment in the acquired comment list relates to one or more specific items. Specifically, regarding one of the comments in the friend comment list, the decision unit 432 divides the comment into phrase units by using a method such as morphological analysis. Subsequently, using the decision feature DB 431, the decision unit 432 decides whether the value of the specific item flag of each phrase included in the comment is “True” or it is “False,” and finds the score of each phrase. Further, the decision unit 432 separately tallies the score of each phrase included in the comment, for a phrase with a specific item flag value of “True” and a phrase with a specific item flag value of “False.”

Subsequently, in a case where the sum of scores of phrases with a specific item flag value of “True” is larger than the sum of scores of phrases with a specific item flag value of “False,” the decision unit 432 decides that the comment relates to one or more specific items. On the other hand, in a case where the sum of scores of phrases with a specific item flag value of “True” is equal to or smaller than the sum of scores of phrases with a specific item flag value of “False,” the decision unit 432 decides that the comment does not relate to one or more specific items.

The decision unit 432 performs this decision processing on all comments in the friend comment list. Subsequently, the decision unit 432 supplies the decision result to the recommendation comment list generation unit 433 together with the friend comment list.

In step S522, the recommendation comment list generation unit 433 extracts high-ranking comments from comments related to one or more specific items, and generates a recommendation comment list. Specifically, the recommendation comment list generation unit 433 extracts comments decided to be related to one or more specific items, from the friend comment list.

Also, for example, the recommendation comment list generation unit 433 extracts a predetermined number of comments in order from the one with the highest expectation value, from the extracted comments, as recommendation comments. Alternatively, for example, the recommendation comment list generation unit 433 extracts comments with expectation values equal to or greater than a predetermined threshold, as recommendation comments, from the extracted comments. Subsequently, the recommendation comment list generation unit 433 generates a recommendation comment list including the extracted recommendation comments and supplies it to the presentation control unit 43.

After that, the recommendation comment extraction processing is terminated.

Returning to FIG. 36, in step S504, the presentation control unit 43 controls the presentation of comments. Specifically, the presentation control unit 43 generates presentation control data to present a comment included in the recommendation comment list. Subsequently, the presentation control unit 43 transmits the generated presentation control data to the viewer's client 12 through the communication unit 31 and the network 13.

The output control unit 102 of the viewer's client 12 receives the presentation control data through the communication unit 101. The output control unit 102 arranges the comments included in the recommendation comment list in order from the latest one, for example, based on the presentation control data, and displays the result in the output unit 103.

After that, the comment presentation processing is terminated.

By this means, it is possible to preferentially present a comment, which is highly likely to be beneficial for the viewer and relates to one or more specific items, to the viewer. Subsequently, through the presented comment, it is possible to recommend an item treated in the comment to the viewer. Therefore, for example, on a social service, it is possible to efficiently recommend various items to each user and encourage the user to take a specific action such as item purchase.

### [Alternation Example of Recommendation Comment Extraction Unit]

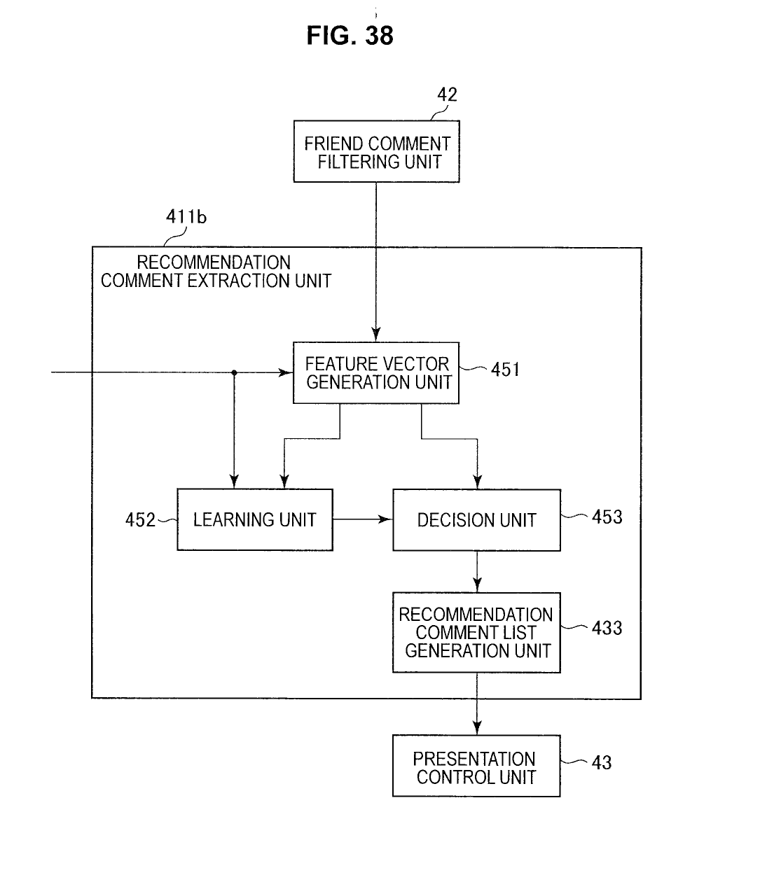

FIG. 38 is a block diagram illustrating a functional configuration example of a recommendation comment extraction unit 411b which is an alternation example of the recommendation comment extraction unit 411 of the server 11c. Also, in the drawing, the same reference numerals are assigned to parts corresponding to FIG. 34, and, regarding parts with the same processing, their explanation is repeated and therefore omitted.

The recommendation comment extraction unit 411b and the recommendation comment extraction unit 411a in FIG. 34 are common in that the recommendation comment list generation unit 433 is included, and they are different in that a feature vector generation unit 451, a learning unit 452 and a decision unit 453 are provided instead of the decision feature DB 431 and the decision unit 432.

The feature vector generation unit 451 generates a feature vector acquired by vectorizing a comment included in teacher data given from the outside, by a predetermined method. Also, the teacher data includes a comment as problem data and answer data indicating whether the comment relates to one or more specific items.

Although a method of generating the feature vector is not limited to a specific method, for example, the feature vector generation unit 451 divides a comment into word units by morphological analysis and, based on the characteristic amount of each word or the like, generates a feature vector corresponding to the comment. The feature vector generation unit 451 supplies the generated feature vector to the learning unit 452.

Also, by the similar method, the feature vector generation unit 451 generates the feature vector with respect to each comment in the friend comment list supplied from the friend comment filtering unit 42. The feature vector generation unit 451 supplies the generated feature vector to the decision unit 453 together with the friend comment list.

The learning unit 452 learns a decision model to decide whether a comment relates to one or more specific items. Specifically, the learning unit 452 forms the decision model using a predetermined learning model, based on the feature vector supplied from the feature vector generation unit 451 and answer data included in learning data given from the outside. Here, an arbitrary learning model such as SVM (Support Vector Machine) is applicable to the learning unit 452. The learning unit 452 supplies the formed decision model to the decision unit 453.

The decision unit 453 decides whether each comment in the friend comment list relates to one or more specific items, using the decision model. The decision unit 453 supplies the decision result to the recommendation comment list generation unit 433 together with the friend comment list.

### (Recommendation Comment Extraction Processing)

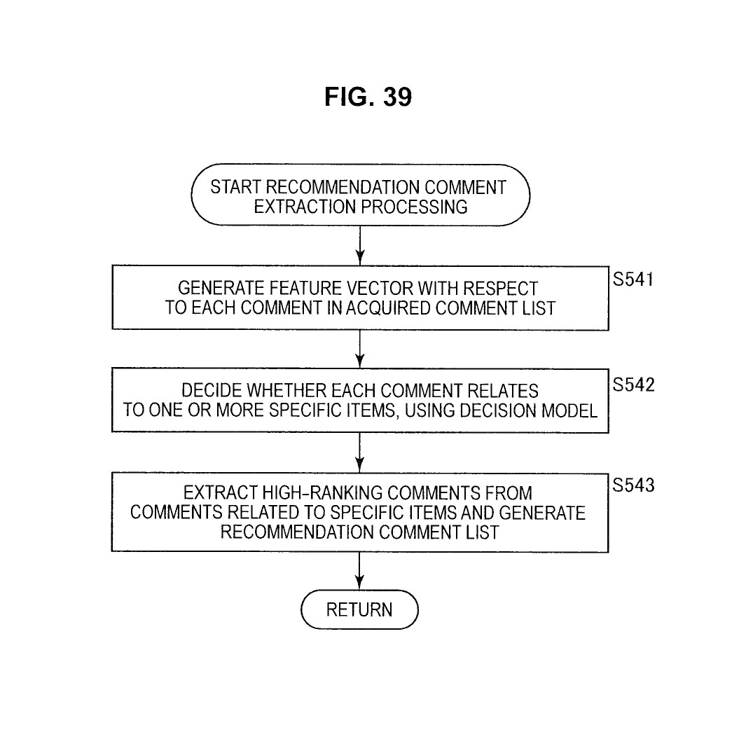

Next, with reference to the flowchart in FIG. 39, an explanation is given to details of the recommendation comment extraction processing performed in step S503 in FIG. 36 in a case where the recommendation comment extraction unit 411b is adopted.

In step S541, the feature vector generation unit 451 generates the feature vector of each comment in the acquired comment list. The feature vector generation unit 451 supplies the generated feature vector to the decision unit 453 with the friend comment list.

In step S542, the decision unit 453 decides whether each comment relates to one or more specific items, using the decision model formed in the learning unit 452, based on the feature vector of each comment in the acquired comment list. Subsequently, the decision unit 432 supplies the distinction result to the recommendation comment list generation unit 433 together with the friend comment list.

In step S543, the same processing as in step S522 in FIG. 37 is performed. By this means, a recommendation comment list is generated by the recommendation comment list generation unit 433 and supplied to the presentation control unit 43.

After that, the recommendation comment extraction processing is terminated.

By performing the learning processing as above, it is possible to extract a comment related to one or more specific items more accurately and present it to the viewer.

### 5. Fourth Embodiment

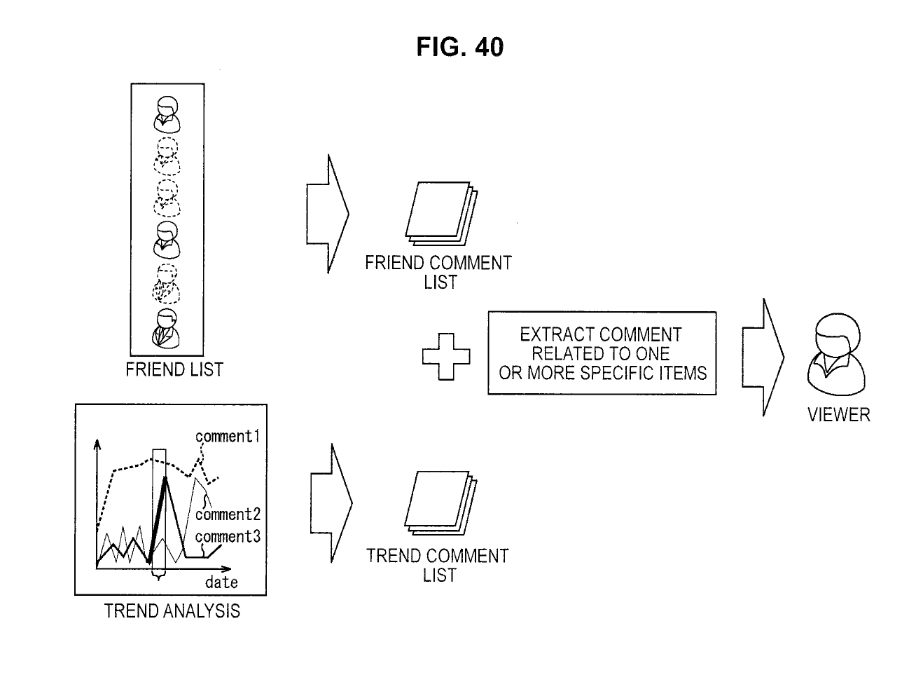

Next, with reference to FIG. 40 to FIG. 42, the fourth embodiment of the present disclosure is explained.

### [Outline of Comment Filtering Function According to the Fourth Embodiment]

First, with reference to FIG. 40, an explanation is given to an outline of a comment filtering function realized in the fourth embodiment of the present disclosure.

This comment filtering function combines the above second embodiment and the above third embodiment. That is, a synthesis comment list is generated by synthesizing the friend comment list and the trend comment list, and a comment related to one or more specific items is extracted from the synthesis comment list and presented to the viewer.

### [Configuration Example of Server 11d]

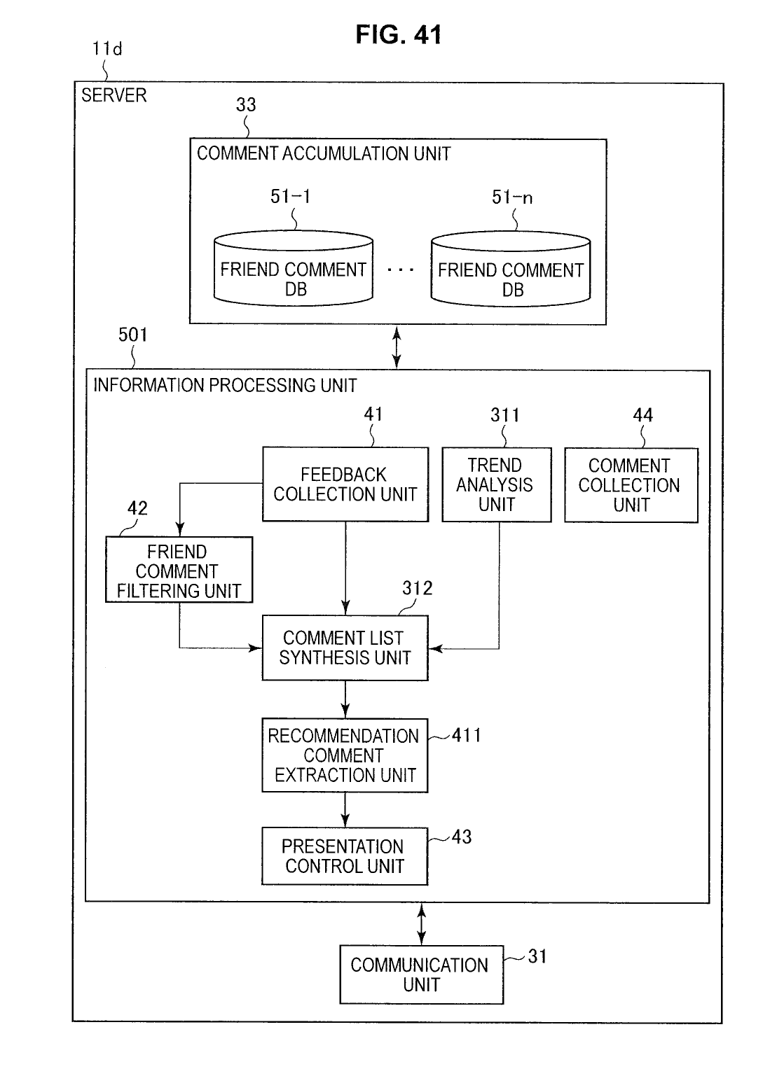

FIG. 41 is a block diagram illustrating a functional configuration example of a server 11d which is the fourth embodiment of the server 11 in the information processing system 1. Here, FIG. 41 illustrates a configuration example of parts to perform processing chiefly related to comment presentation among functions of the server 11d. Also, in the drawing, the same reference numerals are assigned to parts corresponding to FIG. 25 and FIG. 33, and, regarding parts with the same processing, their explanation is repeated and therefore omitted.

The server 11d and the server 11b in FIG. 25 are common in that the communication unit 31 and the comment accumulation unit 33 are included, and they are different in that an information processing unit 501 is provided instead of the information processing unit 301. Further, the information processing unit 501 and the information processing unit 301 are common in that the feedback collection unit 41, the friend comment filtering unit 42, the presentation control unit 43, the comment collection unit 44, the trend analysis unit 311 and the comment list synthesis unit 312 are included, and they are different in that the recommendation comment extraction unit 411 is added.

Here, as the friend comment filtering unit 42, it is possible to adopt any of the friend comment filtering unit 42a in FIG. 5 and the friend comment filtering unit 42b in FIG. 20. Also, as the recommendation comment extraction unit 411, it is possible to adopt any of the recommendation comment extraction unit 411a in FIG. 34 and the recommendation comment extraction unit 411b in FIG. 38.

The recommendation comment extraction unit 411 extracts a comment related to one or more specific items as a recommendation comment, from the synthesis comment list supplied from the comment list synthesis unit 312. The recommendation comment extraction unit 411 generates a recommendation comment list including the extracted recommendation comment and supplies it to the presentation control unit 43.

### [Processing in Server 11d]

Next, processing in the server 11d is explained.

In the server 11d, in a case where a feedback is received from the client 12, similar to the server 11a, at least one of the processing described above is performed with reference to FIG. 9, FIG. 16 or FIG. 18. Here, processing to be performed varies depending on the type of the friend filtering unit 71 included in the server 11d.

Also, in a case where the server 11d has two or more kinds of friend filtering units 71, when a feedback is received from the client 12, the above friend list synthesis weight learning processing is performed with reference to FIG. 23.

Further, in a case where a feedback is received from the client 12, the above comment list synthesis weight learning processing is performed with reference to FIG. 31.

### (Comment Presentation Processing)

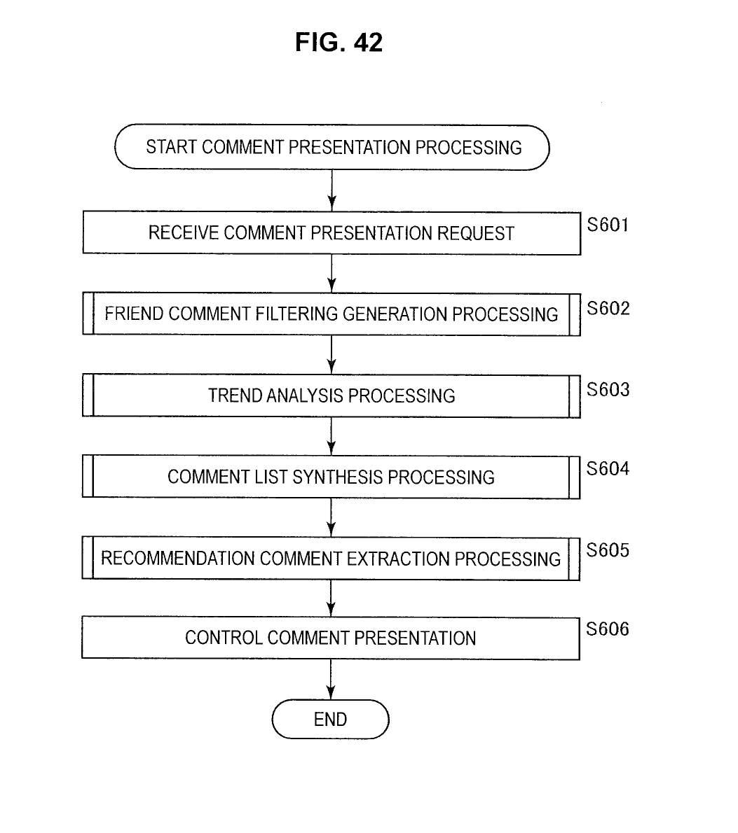

Next, with reference to the flowchart in FIG. 42, an explanation is given to the comment presentation processing performed in the server 11d. Here, for example, this processing starts at the time when: an arbitrary user (e.g. viewer) of the social service performs an operation of displaying a friend's comment in the client 12; and, as a result, a request for comment presentation is transmitted from the client 12 to the server 11d through the network 13.

In step S601, the friend comment filtering unit 42 and the trend analysis unit 311 receive the comment presentation request transmitted from the client 12, through the communication unit 31.

In step S602, the above friend comment filtering processing is performed with reference to FIG. 12 or FIG. 22. By this means, a friend comment list is generated by the friend comment filtering unit 42 and supplied to the comment list synthesis unit 312.

In step S603, the above trend analysis processing is performed with reference to FIG. 29. By this means, a trend comment list is generated by the trend analysis unit 311 and supplied to the comment list synthesis unit 312.

In step S604, the above comment list synthesis processing is performed with reference to FIG. 30. By this means, the friend comment list and the trend comment list are synthesized by the comment list synthesis unit 312, and the resulting synthesis comment list is supplied to the recommendation comment extraction unit 411.

In step S605, the above recommendation comment extraction processing is performed with reference to FIG. 37 or FIG. 39. By this means, the recommendation comment extraction unit 411 extracts a comment related to one or more specific items, as a recommendation comment, from the synthesis comment list. Subsequently, the recommendation comment extraction unit 411 generates a recommendation comment list including the extracted recommendation comment and supplies it to the presentation control unit 43.

In step S606, the presentation control unit 43 controls the presentation of comments. Specifically, the presentation control unit 43 generates presentation control data to present a comment included in the recommendation comment list. Subsequently, the presentation control unit 43 transmits the generated presentation control data to the viewer's client 12 through the communication unit 31 and the network 13.

The output control unit 102 of the viewer's client 12 receives the presentation control data through the communication unit 101. The output control unit 102 arranges the comments included in the recommendation comment list in order from the latest one, for example, based on the presentation control data, and displays the result in the output unit 103.

After that, the comment presentation processing is terminated.

By this means, it is possible to preferentially present a comment related to one or more specific items to the viewer among friend's comments with high viewer's evaluation and comments related to a seasonal topic attracting a lot of attention in the viewer's friends. Therefore, for example, on a social service, it is possible to recommend various items to each user more efficiently and encourage the user to take a specific action such as item purchase.

### 6. Alternation Example

In the following, an explanation is given to an alternation example of the above embodiments of the present disclosure.

### Alternation Example 1

### Example of Combination of Embodiments

As described above, seven kinds of friend comment filtering processing are broadly provided, and, for each of them, trend analysis processing and recommendation comment extraction processing can be individually applied. Therefore, except for detailed alternation examples, 7×2×2=28 kinds of combinations in total are roughly possible.

### Alternation Example 2

### Alternation Example of Link User

In the above explanation, an example has been illustrated where a comment of viewer's friend (i.e. a comment of the user who is bidirectionally linked to the viewer) is presented, for example, the present disclosure is applicable even to a case where a comment of the user who is unidirectionally linked to the viewer is presented.

For example, the present disclosure is applicable even to a case where, while the viewer performs setting so as to view comments, the communicating party presents comments of other users who are not set so as to view a viewer's comment to the viewer. In this case, the viewer is a so-called “follower” and other users are so-called “followee.”

### Alternation Example 3

### Alternation Example of Friend List

In the above explanation, although an example has been illustrated where a friend list (whole) is generated with respect to all users of a social service, it is not requested to be generated with respect to all users in the service but may be generated with respect to users within a partial predetermined range. For example, it is possible to generate the friend list (whole) for the user who has one or more common features (e.g. age group, sex, place of residence, occupation, hobby, and so on) with the viewer.

Here, although it is preferable to set the users within the above predetermined range to include the viewer and all of viewer's friends, it is not requested at any time and it is possible to include or exclude only part of them.

Also, it is possible to exclude the viewer himself/herself from the target users of the friend list (friend). That is, it is possible to generate the friend list (friend) based on only feedbacks from viewer's friends except the viewer.

### Alternation Example 4

### Alternation Example of Trend List

In the above explanation, although an example has been illustrated where a trend comment list is generated with respect to comments sent by viewer's friends, for example, it may be generated with respect to all user's comments or comments within a predetermined range of users. For example, in a case where the trend comment list is generated with respect to comments, it is possible to preferentially present comments related to a seasonal topic attracting a lot of attention in the entire social service.

### Alternation Example 5

### Alternation Example of Synthesis Weights for Friend List and Comment List

In the above explanation, an example has been illustrated where the synthesis weights (α, β, γ) for the friend list and the synthesis weights (W1, W2) for the comment list are learned every user and different weights are used every user, they may be learned for all users or every users within a predetermined range and common weights may be used during a plurality of users.

Also for example, the initial values of weights before learning may be commonly set for all users, may be set to different values based on user's characteristics or may be set by each user.

Further, the weights may be set by the user or adjusted to fixed values without performing the learning processing.

### Alternation Example 6

### Alternation Example of Presentation Information

In the above explanation, although an example has been illustrated where the present disclosure is applied to the case of presenting comments sent from other users, it is applicable to the case of presenting other kinds of information sent from other users. For example, text data other than comments, images, sound, position information and information related to users' activities are possible.

Also, depending on the information type, although it may be assumed that it is difficult to decide whether it relates to one or more specific items, in a case where such information is presented, it is desirable not to apply the above recommendation comment extraction processing.

[Configuration Example of Computer]

The series of processes described above can be executed by hardware but can also be executed by software. When the series of processes is executed by software, a program that constructs such software is installed into a computer. Here, the expression “computer” includes a computer in which dedicated hardware is incorporated and a general-purpose personal computer or the like that is capable of executing various functions when various programs are installed.

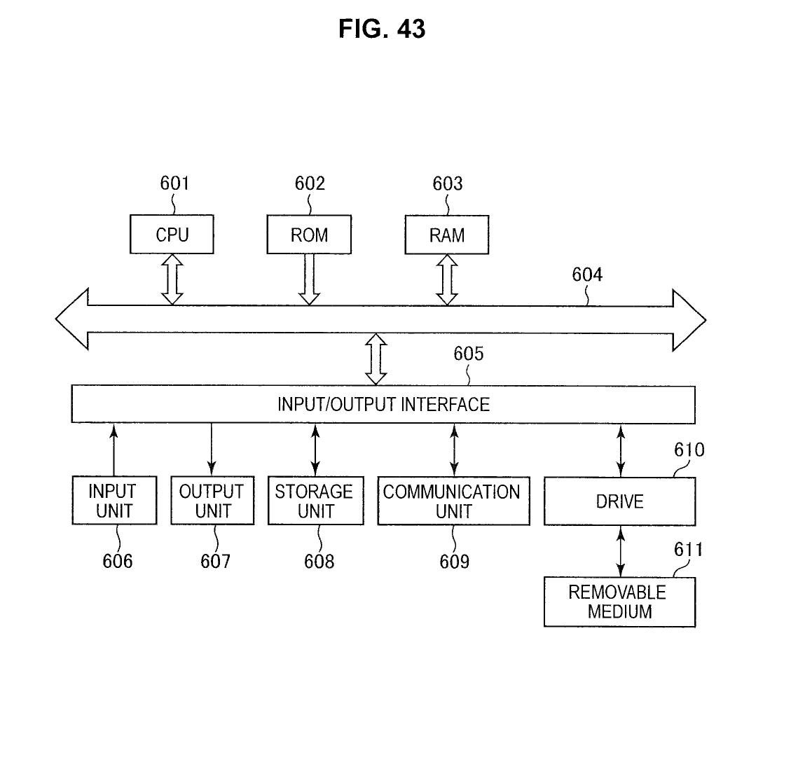

FIG. 43 is a block diagram showing an example configuration of the hardware of a computer that executes the series of processes described earlier according to a program.

In the computer, a central processing unit (CPU) 601, a read only memory (ROM) 602 and a random access memory (RAM) 603 are mutually connected by a bus 604.

An input/output interface 605 is also connected to the bus 604. An input unit 606, an output unit 607, a storage unit 608, a communication unit 609, and a drive 610 are connected to the input/output interface 605.

The input unit 606 is configured from a keyboard, a mouse, a microphone or the like. The output unit 607 is configured from a display, a speaker or the like. The storage unit 608 is configured from a hard disk, a non-volatile memory or the like. The communication unit 609 is configured from a network interface or the like. The drive 610 drives a removable media 611 such as a magnetic disk, an optical disk, a magneto-optical disk, a semiconductor memory or the like.

In the computer configured as described above, the CPU 601 loads a program that is stored, for example, in the storage unit 608 onto the RAM 603 via the input/output interface 605 and the bus 604, and executes the program. Thus, the above-described series of processing is performed.

Programs to be executed by the computer (the CPU 601) are provided being recorded in the removable media 611 which is a packaged media or the like. Also, programs may be provided via a wired or wireless transmission medium, such as a local area network, the Internet or digital satellite broadcasting.

Then, by inserting the removable media 611 into the drive 610, the program can be installed in the storage unit 608 via the input/output interface 605. Further, the program can be received by the communication unit 609 via a wired or wireless transmission media and installed in the storage unit 608. Moreover, the program can be installed in advance in the ROM 602 or the storage unit 608.

It should be noted that the program executed by a computer may be a program that is processed in time series according to the sequence described in this specification or a program that is processed in parallel or at necessary timing such as upon calling.

Further, in the present disclosure, a system has the meaning of a set of a plurality of configured elements (such as an apparatus or a module (part)), and does not take into account whether or not all the configured elements are in the same casing. Therefore, the system may be either a plurality of apparatuses, stored in separate casings and connected through a network, or a plurality of modules within a single casing.

The embodiment of the present technology is not limited to the above-described embodiment. It should be understood by those skilled in the art that various modifications, combinations, sub-combinations and alterations may occur depending on design requirements and other factors insofar as they are within the scope of the appended claims or the equivalents thereof.

For example, the present disclosure can adopt a configuration of cloud computing which processes by allocating and connecting one function by a plurality of apparatuses through a network.

Further, each step described by the above mentioned flow charts can be executed by one apparatus or by allocating a plurality of apparatuses.

In addition, in the case where a plurality of processes is included in one step, the plurality of processes included in this one step can be executed by one apparatus or by allocating a plurality of apparatuses.

Additionally, the present technology may also be configured as below.

(1) An information processing apparatus including:

a user extraction unit extracting, from second users whose information is set to be viewed by a first user in a service in which it is possible to view information sent by other users, a presentation target user to present information to the first user, based on at least one of a first evaluation with respect to each of the second users by the first user, a second evaluation with respect to each of the second users within a range of the first user and the second users, and a third evaluation with respect to each of the second users within a predetermined range of users in the service;

a first information extraction unit extracting information presented to the first user, from information sent from the presentation target user; and

a presentation control unit controlling presentation of information to the first user.

(2) The information processing apparatus according to (1), further including:

a second information extraction unit extracting information whose evaluation greatly varies, from information sent from the second users; and

a third information extraction unit extracting information presented to the first user, from the information extracted by the first information extraction unit and the second information extraction unit.

(3) The information processing apparatus according to (2), further including a fourth information extraction unit extracting information recommended to the first user as information presented to the user, from the information extracted by the third information extraction unit.
(4) The information processing apparatus according to (3), wherein the fourth information extraction unit extracts information related to one or more specific items, as the information recommended to the first user.
(5) The information processing apparatus according to any one of (2) to (4), wherein the second information extraction unit extracts information whose evaluation greatly varies, based on a ratio between an evaluation movement deviation in an immediate period and an evaluation movement deviation in a previous period.
(6) The information processing apparatus according to any one of (2) to (5), wherein the third information extraction unit extracts information presented to the first user after adding a weight depending on from which of the first information extraction unit and the second information extraction unit the information is extracted.
(7) The information processing apparatus according to (6), further including a learning unit learning the weight based on whether information which is presented to the first user and to which the first user givens an evaluation is extracted by the first information extraction unit or the information is extracted by the second information extraction unit.
(8) The information processing apparatus according to (2), further including a second information extraction unit extracting information recommended to the first user as information presented to the user, from the information extracted by the first information extraction unit.
(9) The information processing apparatus according to (8), wherein the second information extraction unit extracts information related to one or more specific items, as information recommended to the first user.
(10) The information processing apparatus according to any one of (1) to (9), wherein the user extraction unit calculates an expectation value that the first user gives a positive evaluation to a comment sent by each of the second users, based on at least one of the first evaluation, the second evaluation, and the third evaluation, and extracts the presentation target user based on the expectation value.
(11) The information processing apparatus according to (10), wherein the user extraction unit adds a weight according to a time period in which an evaluation is given, and calculates the expectation value.
(12) The information processing apparatus according to any one of (1) to (11), wherein the user extraction unit extracts the presentation target user by using a result of adding weights to at least two of the first evaluation, the second evaluation, and the third evaluation.
(13) The information processing apparatus according to (12), further including a learning unit learning the weights based on a type of an evaluation used to extract the presentation target user who sends information which is presented to the first user and to which the first user gives an evaluation.
(14) An information processing method in an information processing apparatus that provides a service in which it is possible to view information sent by other users, the method including:

extracting, from second users whose information is set to be viewed by a first user in the service, a presentation target user to present information to the first user, based on at least one of a first evaluation with respect to each of the second users by the first user, a second evaluation with respect to each of the second users within a range of the first user and the second users, and a third evaluation with respect to each of the second users within a predetermined range of users in the service;

extracting information presented to the first user, from information sent from the presentation target user; and

controlling presentation of information to the first user.

(15) An information processing system including:

a server providing a service in which it is possible to view information sent by other users; and

a client receiving a provision of the service,

wherein the server includes:
a user extraction unit extracting, from second users whose information is set to be viewed by a first user in the service, a presentation target user to present information to the first user, based on at least one of a first evaluation with respect to each of the second users by the first user, a second evaluation with respect to each of the second users within a range of the first user and the second users, and a third evaluation with respect to each of the second users within a predetermined range of users in the service;
an information extraction unit extracting information presented to the first user, from information sent from the presentation target user; and
a presentation control unit controlling presentation of information to the first user.
   (16) An information processing apparatus including:

a user extraction unit extracting, from second users whose information is set to be viewed by a first user in a service in which it is possible to view information sent by other users, a presentation target user to present information to the first user, based on an evaluation with respect to each of the second users by the first user;

an information extraction unit extracting information presented to the first user, from information sent from the presentation target user; and

a presentation control unit controlling presentation of information to the first user.

The present disclosure contains subject matter related to that disclosed in Japanese Priority Patent Application JP 2012-170729 filed in the Japan Patent Office on Aug. 1, 2012, the entire content of which is hereby incorporated by reference.

What is claimed is:

1. An information processing apparatus comprising:
a user extraction unit extracting, from second users whose information is set to be viewed by a first user in a service in which it is possible to view information sent by other users, a presentation target user to present information to the first user, based on at least one of a first evaluation with respect to each of the second users by the first user, a second evaluation with respect to each of the second users within a range of the first user and the second users, and a third evaluation with respect to each of the second users within a predetermined range of users in the service;
a first information extraction unit extracting information presented to the first user, from information sent from the presentation target user; and
a presentation control unit controlling presentation of information to the first user.

2. The information processing apparatus according to claim 1, further comprising:
a second information extraction unit extracting information whose evaluation greatly varies, from information sent from the second users; and
a third information extraction unit extracting information presented to the first user, from the information extracted by the first information extraction unit and the second information extraction unit.

3. The information processing apparatus according to claim 2, further comprising a fourth information extraction unit extracting information recommended to the first user as information presented to the user, from the information extracted by the third information extraction unit.

4. The information processing apparatus according to claim 3, wherein the fourth information extraction unit extracts information related to one or more specific items, as the information recommended to the first user.

5. The information processing apparatus according to claim 2, wherein the second information extraction unit extracts information whose evaluation greatly varies, based on a ratio between an evaluation movement deviation in an immediate period and an evaluation movement deviation in a previous period.

6. The information processing apparatus according to claim 2, wherein the third information extraction unit extracts information presented to the first user after adding a weight depending on from which of the first information extraction unit and the second information extraction unit the information is extracted.

7. The information processing apparatus according to claim 6, further comprising a learning unit learning the weight based on whether information which is presented to the first user and to which the first user givens an evaluation is extracted by the first information extraction unit or the information is extracted by the second information extraction unit.

8. The information processing apparatus according to claim 2, further comprising a second information extraction unit extracting information recommended to the first user as information presented to the user, from the information extracted by the first information extraction unit.

9. The information processing apparatus according to claim 8, wherein the second information extraction unit extracts information related to one or more specific items, as information recommended to the first user.

10. The information processing apparatus according to claim 1, wherein the user extraction unit calculates an expectation value that the first user gives a positive evaluation to a comment sent by each of the second users, based on at least one of the first evaluation, the second evaluation, and the third evaluation, and extracts the presentation target user based on the expectation value.

11. The information processing apparatus according to claim 10, wherein the user extraction unit adds a weight according to a time period in which an evaluation is given, and calculates the expectation value.

12. The information processing apparatus according to claim 1, wherein the user extraction unit extracts the presentation target user by using a result of adding weights to at least two of the first evaluation, the second evaluation, and the third evaluation.

13. The information processing apparatus according to claim 12, further comprising a learning unit learning the weights based on a type of an evaluation used to extract the presentation target user who sends information which is presented to the first user and to which the first user gives an evaluation.

14. An information processing method in an information processing apparatus that provides a service in which it is possible to view information sent by other users, the method comprising:
extracting, from second users whose information is set to be viewed by a first user in the service, a presentation target user to present information to the first user, based on at least one of a first evaluation with respect to each of the second users by the first user, a second evaluation with respect to each of the second users within a range of the first user and the second users, and a third evaluation with respect to each of the second users within a predetermined range of users in the service;
extracting information presented to the first user, from information sent from the presentation target user; and
controlling presentation of information to the first user.

15. An information processing system comprising:
a server providing a service in which it is possible to view information sent by other users; and
a client receiving a provision of the service,
wherein the server includes
a user extraction unit extracting, from second users whose information is set to be viewed by a first user in the service, a presentation target user to present information to the first user, based on at least one of a first evaluation with respect to each of the second users by the first user, a second evaluation with respect to each of the second users within a range of the first user and the second users, and a third evaluation with respect to each of the second users within a predetermined range of users in the service,
an information extraction unit extracting information presented to the first user, from information sent from the presentation target user, and
a presentation control unit controlling presentation of information to the first user.

16. An information processing apparatus comprising:
a user extraction unit extracting, from second users whose information is set to be viewed by a first user in a service in which it is possible to view information sent by other users, a presentation target user to present information to the first user, based on an evaluation with respect to each of the second users by the first user;
an information extraction unit extracting information presented to the first user, from information sent from the presentation target user; and
a presentation control unit controlling presentation of information to the first user.
